(19) United States
(12) Patent Application Publication
(10) Pub. No.: US 2013/0177078 A1
(43) Pub. Date: Jul. 11, 2013

(54) APPARATUS AND METHOD FOR ENCODING/DECODING VIDEO USING ADAPTIVE PREDICTION BLOCK FILTERING

(71) Applicants: Ha Hyun Lee, Seoul (KR); Hui Yong Kim, Daejeon (KR); Sung Chang Lim, Daejeon (KR); Se Yoon Jeong, Daejeon (KR); Jong Ho Kim, Daejeon (KR); Jin Ho Lee, Daejeon (KR); Suk Hee Cho, Daejeon (KR); Jin Soo Choi, Daejeon (KR); Jin Woong Kim, Daejeon (KR); Chie Teuk Ahn, Daejeon (KR); Sung Jea Ko, Seoul (KR); Yeo Jin Yoon, Seoul (KR); Keun Yung Byun, Seoul (KR)

(72) Inventors: Ha Hyun Lee, Seoul (KR); Hui Yong Kim, Daejeon (KR); Sung Chang Lim, Daejeon (KR); Se Yoon Jeong, Daejeon (KR); Jong Ho Kim, Daejeon (KR); Jin Ho Lee, Daejeon (KR); Suk Hee Cho, Daejeon (KR); Jin Soo Choi, Daejeon (KR); Jin Woong Kim, Daejeon (KR); Chie Teuk Ahn, Daejeon (KR); Sung Jea Ko, Seoul (KR); Yeo Jin Yoon, Seoul (KR); Keun Yung Byun, Seoul (KR)

(73) Assignee: Electronics and Telecommunications Research Institute, Daejeon (KR)

(21) Appl. No.: 13/822,956

(22) PCT Filed: Sep. 30, 2011
(86) PCT No.: PCT/KR2011/007261

§ 371 Date: Mar. 13, 2013

(30) Foreign Application Priority Data
Sep. 30, 2010 (KR) 10-2010-0095055
Sep. 30, 2011 (KR) 10-2011-0099681

(51) Int. Cl. H04N 7/26

(52) U.S. Cl. CPC H04N 19/00569
USPC 375/240.12

(57) ABSTRACT

Provided are a method and apparatus for encoding/decoding video. The method and apparatus of the present invention involve generating a first prediction block for a block to be decoded, calculating a filter coefficient on the basis of the block adjacent to the first prediction block, and performing filtering on the first prediction block using the filter coefficient so as to generate a second prediction block if information relating to the performance of filtering indicates that filtering should be performed. According to the present invention, accuracy in video prediction and encoding performance are improved.

### TECHNICAL FIELD

The present invention relates to a video processing technology, and more particularly, to a video coding/decoding method and apparatus.

### BACKGROUND ART

Recently, in accordance with the expansion of broadcasting services having high definition (HD) resolution (1280×1024 or 1920×1080) domestically and around the world, many users have been accustomed to a high resolution and high definition video, such that many organizations have conducted many attempts to develop the next-generation video devices. In addition, as the interest in an HDTV and ultra high definition (UHD) having a resolution four times higher than that of the HDTV have been increased, video standardization organizations have recognized the necessity for a compression technology for a higher-resolution and higher-definition video. In addition, a new standard capable of providing many gains in terms of a frequency band or storage while providing video quality as an existing coding scheme through compression efficiency higher than that of H.264/advanced video coding (AVC), which is a moving picture compression coding standard currently used in an HDTV, a mobile phone, or the like, has been demanded. Currently, the moving picture experts group (MPEG) and the video coding experts group (VCEG) have jointly conducted standardization for high efficiency video coding (HEVC), which is the next generation video codec. A rough object of the HEVC is to code a video including a UHD video at compression efficiency two times higher than compression efficiency in H.264/AVC. The HEVC may provide a high definition video at a frequency lower than a current frequency even in 3D broadcasting and a mobile communication network as well as HD and UHD videos.

In the HEVC, a picture is spatially or temporally predicted, such that a prediction picture may be generated and a difference between an original picture and the prediction picture may be coded. The efficiency of the video coding may be increased by the prediction coding.

The existing video coding method has suggested technologies of further improving accuracy of a prediction picture in order to improve coding performance. In order to improve the accuracy of the prediction picture, the existing video coding method generally allows an interpolation picture of a reference picture to be accurate or predicts a difference signal once more.

### DISCLOSURE

### Technical Problem

The present invention provides a video coding apparatus and method using adaptive prediction block filtering.

The present invention also provides a video coding apparatus and method having high prediction picture accuracy and improved coding performance.

The present invention also provides a video coding apparatus and method capable of minimizing added coding information.

The present invention also provides a video decoding apparatus and method using adaptive prediction block filtering.

The present invention also provides a video decoding apparatus and method having high prediction picture accuracy and improved coding performance.

The present invention also provides a video decoding apparatus and method capable of minimizing coding information transmitted from a coding apparatus.

### Technical Solution

In an aspect, a video decoding method is provided. The video decoding method includes: generating a first prediction block for a decoding object block; calculating a filter coefficient based on neighboring blocks of the first prediction block; and generating a second prediction block by performing filtering on the first prediction block using the filter coefficient when information on whether or not filtering is performed generated in a coding apparatus or a decoding apparatus or stored in the coding apparatus or the decoding apparatus indicates that the filtering is performed, wherein the information on whether or not filtering is performed is information indicating whether or not the filtering is performed on the first prediction block.

The neighboring block may be at least one of a left block and an upper block each adjacent to one surface of the first prediction block and a left uppermost block, a right uppermost block, and a left lowermost block each adjacent to the first prediction block. In the calculating of the filter coefficient, the filter coefficient may be calculated using only some areas within the neighboring block.

In the neighboring block, similarity between a neighboring prediction block for the neighboring block and the first prediction block may be a predetermined threshold or more.

The information on whether or not filtering is performed may be information generated by comparing rate-distortion cost values before and after the filtering is performed on the prediction block of the coding object block with each other in the coding apparatus, indicating that the filtering is not performed when the rate-distortion cost value before the filtering is performed on the prediction block of the coding object block is smaller than the rate-distortion cost value after the filtering is performed on the prediction block of the coding object block, indicating that the filtering is performed when the rate-distortion cost value before the filtering is performed on the prediction block of the coding object block is larger than the rate-distortion cost value after the filtering is performed on the prediction block of the coding object block, and coded in the coding apparatus and transmitted to the decoding apparatus.

The information on whether or not filtering is performed may be information generated based on information on the neighboring block in the decoding apparatus.

The information on whether or not filtering is performed may be generated based on performance of the filtering performed on the neighboring block using the filter coefficient.

The information on whether or not filtering is performed may be generated based on similarity between the prediction block and the neighboring prediction block.

The video decoding method may further include: generating a recovery block using the second prediction block and a recovered residual block when the filtering is performed on the first prediction block; and generating a recovery block using the first prediction block and the recovered residual block when the filtering is not performed on the first prediction block.

In another aspect, a video decoding apparatus is provided. The video decoding apparatus includes: a filter coefficient calculating unit calculating a filter coefficient based on neighboring blocks of a first prediction block; a filtering performing unit generating a second prediction block by performing filtering on the first prediction block using the filter coefficient when information on whether or not filtering is performed generated in a coding apparatus or a decoding apparatus or stored in the coding apparatus or the decoding apparatus indicates that the filtering is performed; and a recovery block generating unit generating a recovery block using the second prediction block and a recovered residual block when the filtering is performed on the first prediction block and generating a recovery block using the first prediction block and the recovered residual block when the filtering is not performed on the first prediction block, wherein the information on whether or not filtering is performed is information indicating whether or not the filtering is performed on the first prediction block.

In still another aspect, a video coding method is provided. The video coding method includes: generating a first prediction block for a coding object block; calculating a filter coefficient based on neighboring blocks of the first prediction block; and generating a second prediction block by performing filtering on the first prediction block using the filter coefficient when information on whether or not filtering is performed generated in a coding apparatus or stored in the coding apparatus indicates that the filtering is performed, wherein the information on whether or not filtering is performed is information indicating whether or not the filtering is performed on the first prediction block.

The neighboring block may be at least one of a left block and an upper block each adjacent to one surface of the first prediction block and a left uppermost block, a right uppermost block, and a left lowermost block each adjacent to the first prediction block.

In the calculating of the filter coefficient, the filter coefficient may be calculated using only some areas within the neighboring block.

The information on whether or not filtering is performed may indicate that the filtering is always performed.

The video coding method may further include: generating a residual block using the first prediction block and an input block when a rate-distortion cost value for the first prediction block is smaller than a rate-distortion cost value for the second prediction block; and generating a residual block using the second prediction block and the input block when the rate-distortion cost value for the first prediction block is larger than the rate-distortion cost value for the second prediction block.

The information on whether or not filtering is performed may be information generated based on information on the neighboring block in the coding apparatus.

The information on whether or not filtering is performed may be generated based on performance of the filtering performed on the neighboring block using the filter coefficient.

The information on whether or not filtering is performed may be generated based on similarity between the prediction block and the neighboring prediction block.

The video coding method may further include: generating a residual block using the second prediction block and an input block when the filtering is performed on the first prediction block; and generating a residual block using the first prediction block and the input block when the filtering is not performed on the first prediction block.

In the generating of the residual block when the filtering is performed on the first prediction block, the residual block may be generated using the first prediction block and the input block when a rate-distortion cost value for the first prediction block is smaller than a rate-distortion cost value for the second prediction block and be generated using the second prediction block and the input block when the rate-distortion cost value for the first prediction block is larger than the rate-distortion cost value for the second prediction block.

### Advantageous Effects

According to the exemplary embodiments of the present invention, accuracy of a prediction picture and coding performance are improved.

### DESCRIPTION OF DRAWINGS

FIG. 1 is a block diagram showing a configuration according to an exemplary embodiment of a video coding apparatus to which the present invention is applied;

FIG. 2 is a block diagram showing a configuration according to an exemplary embodiment of a video decoding apparatus to which the present invention is applied.

FIG. 3 is a conceptual diagram showing the concept of a picture and a block used in an exemplary embodiment of the present invention.

FIG. 4 is a flow chart schematically showing a video coding method using prediction block filtering according to an exemplary embodiment of the present invention.

FIG. 5 is a conceptual diagram showing an exemplary embodiment of a method of selecting neighboring blocks used to calculate a filter coefficient.

FIG. 6 is a flow chart showing another exemplary embodiment of a method of selecting neighboring blocks used to calculate a filter coefficient.

FIG. 7 is a flow chart showing an exemplary embodiment of a method of determining whether or not filtering is performed by judging filtering performance.

FIG. 8 is a flow chart showing an exemplary embodiment of a method of determining whether or not filtering is performed by judging the similarity between a prediction block of a coding object block and neighboring prediction blocks.

FIG. 9 is a flow chart showing an exemplary embodiment of a method of determining a pixel value of a prediction block of a current coding object block.

FIG. 10 is a flow chart showing another exemplary embodiment of a method of determining a pixel value of a prediction block of a current coding object block.

FIG. 11 is a block diagram schematically showing a configuration according to an exemplary embodiment of a prediction block filtering device applied to the video coding apparatus.

FIG. 12 is a flow chart schematically showing a video decoding method using prediction block filtering according to an exemplary embodiment of the present invention.

FIG. 13 is a conceptual diagram showing an exemplary embodiment of a method of selecting neighboring blocks used to calculate a filter coefficient.

FIG. 14 is a flow chart showing an exemplary embodiment of a method of determining whether or not filtering is performed using information on whether or not filtering is performed.

FIG. 15 is a flow chart showing an exemplary embodiment of a method of determining a pixel value of a prediction block of a current decoding object block.

FIG. 16 is a block diagram schematically showing a configuration according to an exemplary embodiment of a prediction block filtering device applied to the video decoding apparatus.

### MODE FOR INVENTION

Hereinafter, exemplary embodiments of the present invention will be described in detail with reference to the accompanying drawings. In describing exemplary embodiments of the present invention, well-known functions or constructions will not be described in detail since they may unnecessarily obscure the understanding of the present invention.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Further, in the present invention, “comprising” a specific configuration will be understood that additional configuration may also be included in the embodiments or the scope of the technical idea of the present invention.

Terms used in the specification, ‘first’, ‘second’, etc., can be used to describe various components, but the components are not to be construed as being limited to the terms. The terms are only used to differentiate one component from other components. For example, the ‘first’ component may be named the ‘second’ component and the ‘second’ component may also be similarly named the ‘first’ component, without departing from the scope of the present invention.

Furthermore, constitutional parts shown in the embodiments of the present invention are independently shown so as to represent different characteristic functions. Thus, it does not mean that each constitutional part is constituted in a constitutional unit of separated hardware or one software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

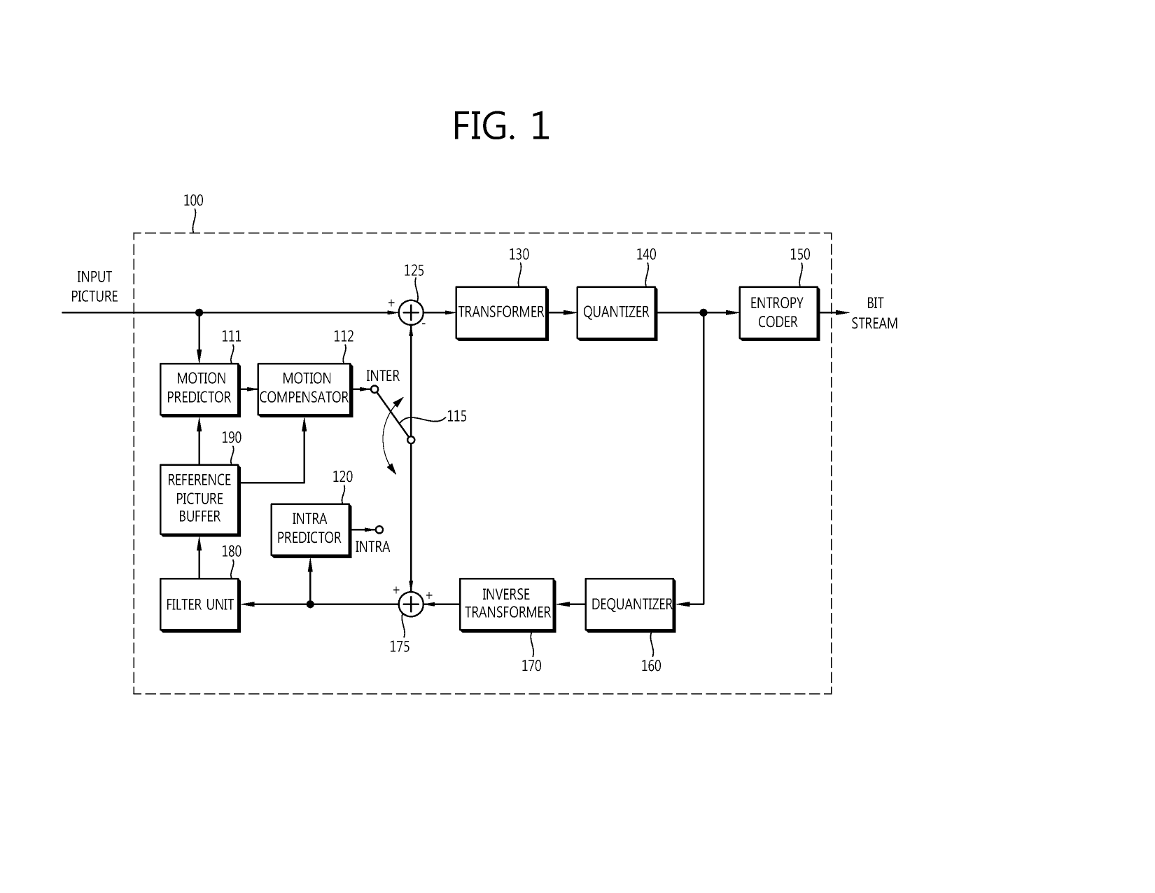

FIG. 1 is a block diagram showing a configuration according to an exemplary embodiment of a video coding apparatus to which the present invention is applied.

Referring to FIG. 1, a video coding apparatus 100 includes a motion predictor 111, a motion compensator 112, an intra predictor 120, a switch 115, a subtracter 125, a transformer 130, a quantizer 140, an entropy-coder 150, a dequantizer 160, an inverse transformer 170, an adder 175, a filter unit 180, and a reference picture buffer 190.

The video coding apparatus 100 performs coding on input pictures in an intra-mode or an inter-mode and outputs bit streams. The intra prediction means intra-frame prediction and the inter prediction means inter-frame prediction. In the case of the intra mode, the switch 115 is switched to intra and in the case of the inter mode, the switch 115 is switched to inter. The video coding apparatus 100 generates a prediction block for an input block of the input picture and then codes a difference between the input block and the prediction block.

In the case of the intra mode, the intra predictor 120 performs spatial prediction using pixel values of already coded blocks adjacent to a current block to generate prediction blocks.

In the inter mode, the motion predictor 111 searches a region optimally matched with the input block in a reference picture stored in the reference picture buffer 190 during a motion prediction process to obtain a motion vector. The motion compensator 112 performs motion compensation by using the motion vector to generate the prediction block.

The subtracter 125 generates a residual block by a difference between the input block and the generated prediction block. The transformer 130 performs transform on the residual block to output transform coefficients. Further, the quantizer 140 quantizes the input transform coefficient according to quantization parameters to output a quantized coefficient. The entropy-coder 150 entropy-codes the input quantized coefficient according to probability distribution to output the bit streams.

Since the HEVC performs inter prediction coding, that is, inter-frame prediction coding, a current coded picture needs to be decoded and stored in order to be used as a reference picture. Therefore, the quantized coefficient is dequantized in the dequantizer 160 and inversely transformed in the inverse transformer 170. The dequantized and inversely transformed coefficient is added to the prediction block through the adder 175, such that a recovery block is generated.

The recovery block passes through the filter unit 180 and the filter unit 180 may apply at least one of a deblocking filter, a sample adaptive offset (SAO), and an adaptive loop filter to a recovery block or a recovered picture. The filter unit 180 may also be called an adaptive in-loop filter. The deblocking filter may remove block distortion generated at an inter-block boundary. The SAO may add an appropriate offset value to a pixel value in order to compensate a coding error. The ALF may perform the filtering based on a comparison value between the recovered picture and the original picture and may also operate only when high efficiency is applied. The recovery block passing through the filter unit 180 may be stored in the reference picture buffer 190.

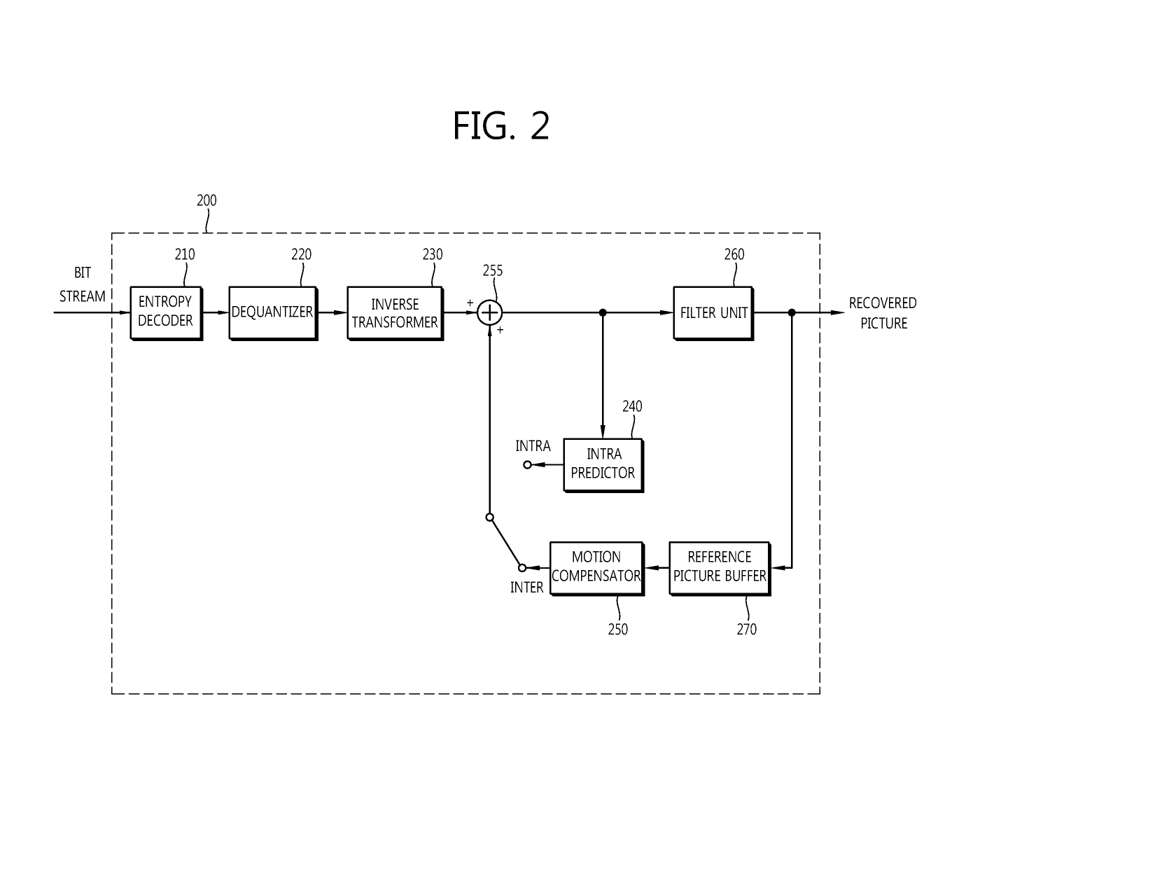

FIG. 2 is a block diagram showing a configuration according to an exemplary embodiment of a video decoding apparatus to which the present invention is applied.

Referring to FIG. 2, a video decoding apparatus 200 includes an entropy-decoder 210, a dequantizer 220, an inverse transformer 230, an intra predictor 240, a motion compensator 250, a filter unit 260, and a reference picture buffer 270.

The video decoding apparatus 200 receives the bit streams output from the coder to perform decoding in the intra mode or the inter mode and outputs the reconstructed picture, that is, the recovered picture. In the case of the intra mode, the switch is switched to the intra and in the case of the inter mode, the switch is switched to the inter mode. The video decoding apparatus 200 obtains a residual block from the received bit streams, generates the prediction block and then adds the residual block to the prediction block, thereby generating the reconstructed block, that is, the recovered block.

The entropy-decoder 210 entropy-codes the input bit streams according to the probability distribution to output the quantized coefficient. The quantized coefficient is dequantized in the dequantizer 220 and inversely transformed in the reverse transformer 230. The quantized coefficient may be dequantized/inversely transformed, such that the residual block is generated.

In the case of the intra mode, the intra predictor 240 performs spatial prediction using pixel values of already coded blocks adjacent to a current block to generate prediction blocks.

In the case of the inter mode, the motion compensator 250 performs the motion compensation by using the motion vector and the reference picture stored in the reference picture buffer 270 to generate the prediction block.

The residual block and the prediction block are added to each other through the adder 255 and the added block passes through the filter unit 260. The filter unit 260 may apply at least one of the deblocking filter, the SAO, and the ALF to the recovery block or the recovered picture. The filter unit 260 outputs the reconstructed pictures, that is, the recovered picture. The recovered picture may be stored in the reference picture buffer 270 so as to be used for the inter-frame prediction.

As a method for improving prediction performance of the coding/decoding apparatus, there are a method of improving accuracy of an interpolation picture and a method of predicting a difference signal. Here, the difference signal means a signal indicating a difference between an original picture and a prediction picture. In the present specification, the “difference signal” may be replaced by a “differential signal”, a “residual block”, or a “differential block” according to a context, which may be distinguished from each other by those skilled in the art without affecting the spirit and scope of the present invention.

Even though the accuracy of the interpolation picture is improved, the difference signal cannot but be generated. Therefore, there is a need to improve the performance of difference signal prediction to maximally reduce a difference signal to be coded, thereby improving the coding performance.

As a method of predicting a difference signal, a filtering method using a fixed filter coefficient may be used. However, this filtering method has a limitation in prediction performance since a filter coefficient may not be adaptively used according to picture characteristics. Therefore, there is a need to allow filtering to be performed to be appropriate for characteristics of each prediction block, thereby improving the accuracy of the prediction.

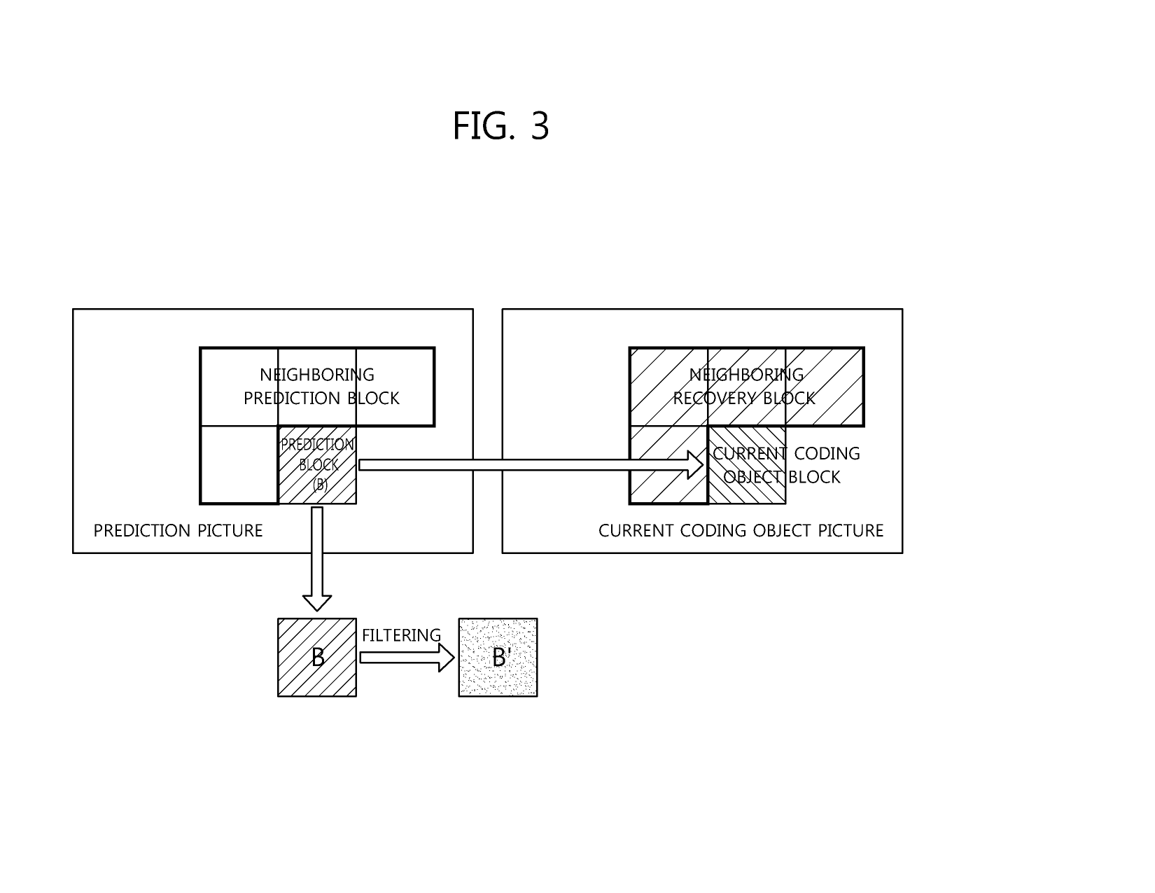

FIG. 3 is a conceptual diagram showing the concept of a picture and a block used in an exemplary embodiment of the present invention.

Referring to FIG. 3, a coding object block is a set of pixels spatially connected to each other within a current coding object picture. The coding object block may be a unit in which coding and decoding are performed and may have a rectangular shape or any shape. Neighboring recovery blocks mean blocks on which coding and decoding are completed before a current coding object block is coded, within the current coding object picture.

A prediction picture is a picture in which prediction blocks used to code each block from a first coding object block of the current coding object picture to a current coding object block thereof are collected, in the current coding object picture. Here, the prediction blocks mean blocks having prediction signals used to code the respective coding object blocks within the current coding object picture. The prediction blocks mean the respective blocks that are within the prediction picture.

Neighboring blocks mean neighboring recovery blocks of the current coding object block and neighboring prediction blocks, which are prediction blocks of the respective neighboring recovery blocks. That is, the neighboring blocks indicate both of the neighboring recovery blocks and the neighboring prediction blocks. The neighboring blocks are blocks used to calculate filter coefficient in the exemplary embodiment of the present invention.

The prediction block B of the current coding object block is filtered according to the exemplary embodiment of the present invention to become a filtered block B′. Specific embodiments will be described with reference to the accompanying drawings below.

Hereinafter, a coding object blocks, a neighboring recovery block, a prediction picture, a prediction block, and a neighboring block will be used as the meaning as defined in FIG. 3.

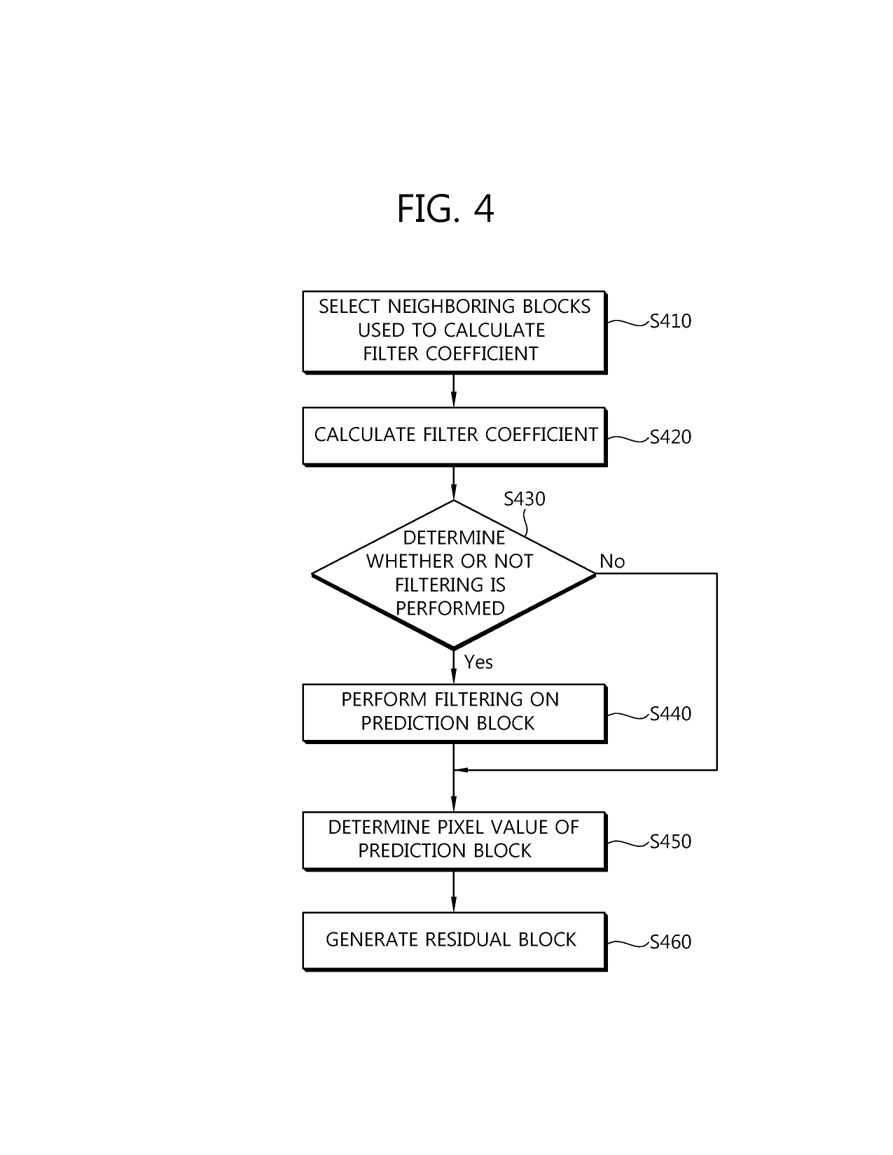

FIG. 4 is a flow chart schematically showing a video coding method using prediction block filtering according to an exemplary embodiment of the present invention. Filtering on a prediction block of a current coding object block may be used in coding a picture. According to the exemplary embodiment of the present invention, the picture is coded using prediction block filtering.

The prediction block, an original block, or a neighboring block of the current coding object block may be used in the prediction block filtering. Here, the original block means a block that is not subjected to a coding process, that is, an input intact block, within the current coding object picture.

The prediction block of the current coding object block may be a prediction block generated in the motion compensator 112 or the intra predictor 120 according to the exemplary embodiment of FIG. 1. In this case, after a prediction block filter process is performed on the prediction block generated in the motion compensator 112 or the intra predictor 120, the subtracter 125 may perform subtraction between the filtered final prediction block and the original block.

The neighboring block may be a block stored in the reference picture buffer 190 according to the exemplary embodiment of FIG. 1 or a separate memory. In addition, a neighboring recovery block or a neighboring prediction block generated during a video coding process may also be used as the neighboring block as it is.

Referring to FIG. 4, the coding apparatus selects neighboring blocks used to calculate a filter coefficient (S410). The neighboring blocks may be used to calculate the filter coefficient. In this case, which block of the neighboring blocks is used may be judged.

As an example, all neighboring recovery blocks adjacent to the coding object block and all neighboring prediction blocks corresponding to the neighboring recovery blocks may be selected as neighboring blocks for calculating the filter coefficient and be used for coding. A set of pixel values of the neighboring blocks used to calculate the filter coefficient may be variously selected.

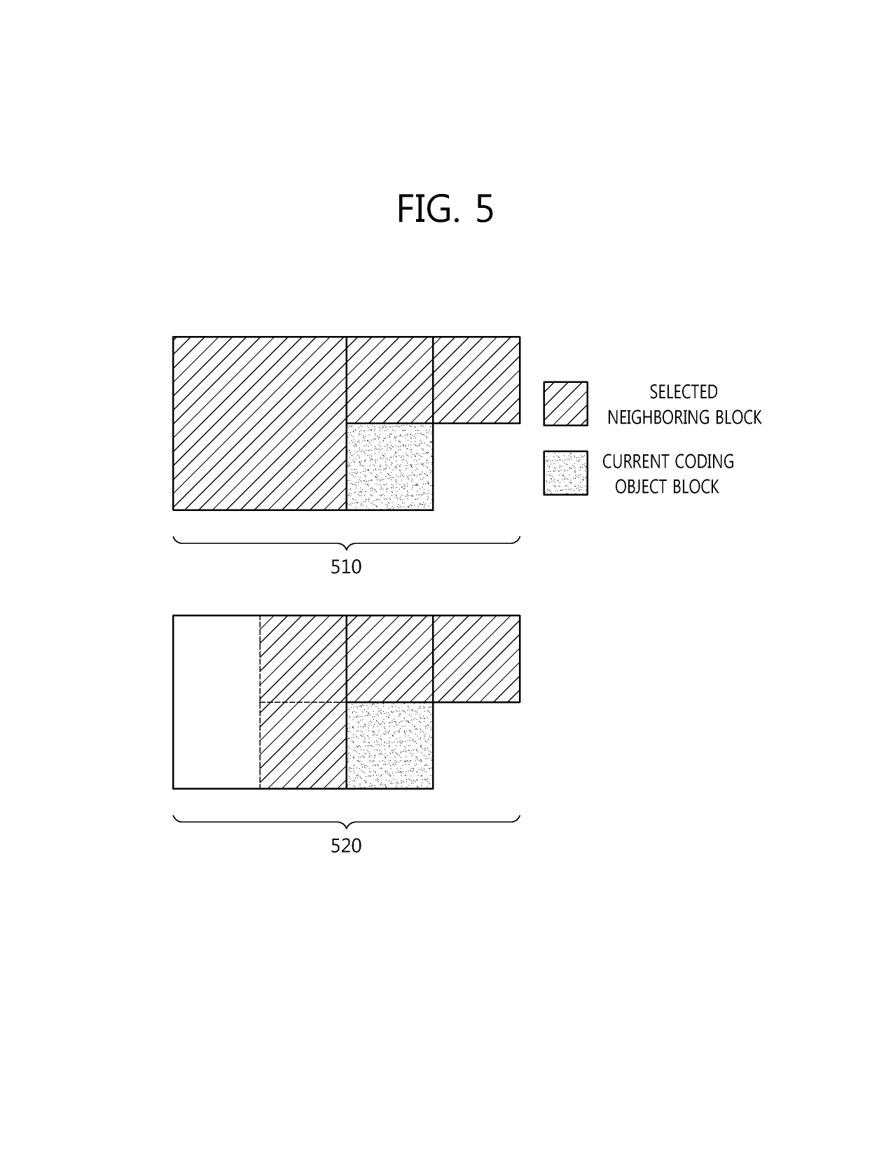

FIG. 5 is a conceptual diagram showing an exemplary embodiment of a method of selecting neighboring blocks used to calculate a filter coefficient. All pixel value areas of adjacent neighboring blocks may be used to calculate the filter coefficient, as shown in an upper portion 510 of FIG. 5. However, only some pixel value areas within adjacent neighboring blocks may also be used to calculate the filter coefficient as shown in a lower portion 520 of FIG. 5.

As an example, it is assumed that a coordinate of a pixel positioned at the leftmost upper portion of the current coding object block is (x, y) and each of a width and a height of a current coding object block is W and H. In this case, a coordinate of a pixel positioned at the rightmost upper portion of the current coding object block is (X+W−1, y). It is assumed that a right direction based on an x-axis is a positive direction and a lower side direction based on a y-axis is a positive direction. In this case, adjacent neighboring blocks may include an upper block including at least one of pixels of a (x˜x+W−1, y−1) coordinate, a left block including at least one of pixels of a (x−1, y˜y+H−1) coordinate, a left upper block including at least one of pixels of a (x−1, y−1) coordinate, a right upper block including at least one of pixels of a (x+W, y−1) coordinate, and a left lower block including at least one of pixels of a (x−1, y+H) coordinate. Here, the upper block and the left block are blocks adjacent to one surface of a prediction block, the left upper block is a left uppermost block adjacent to the prediction block, the right upper block is a right uppermost block adjacent to the prediction block, and the left lower block is a left lowermost block adjacent to the prediction block.

In this case, at least one of the neighboring blocks may be used to calculate the filter coefficient or all of the neighboring blocks may be used to calculate the filter coefficient. Only some pixel value areas within each of the upper block, the left block, the left upper block, the right upper block, and the left lower block may also be used to calculate the filter coefficient.

As another example, only neighboring prediction blocks associated with a prediction block of a current coding object block among possible neighboring blocks and neighboring recovery blocks corresponding thereto may be used.

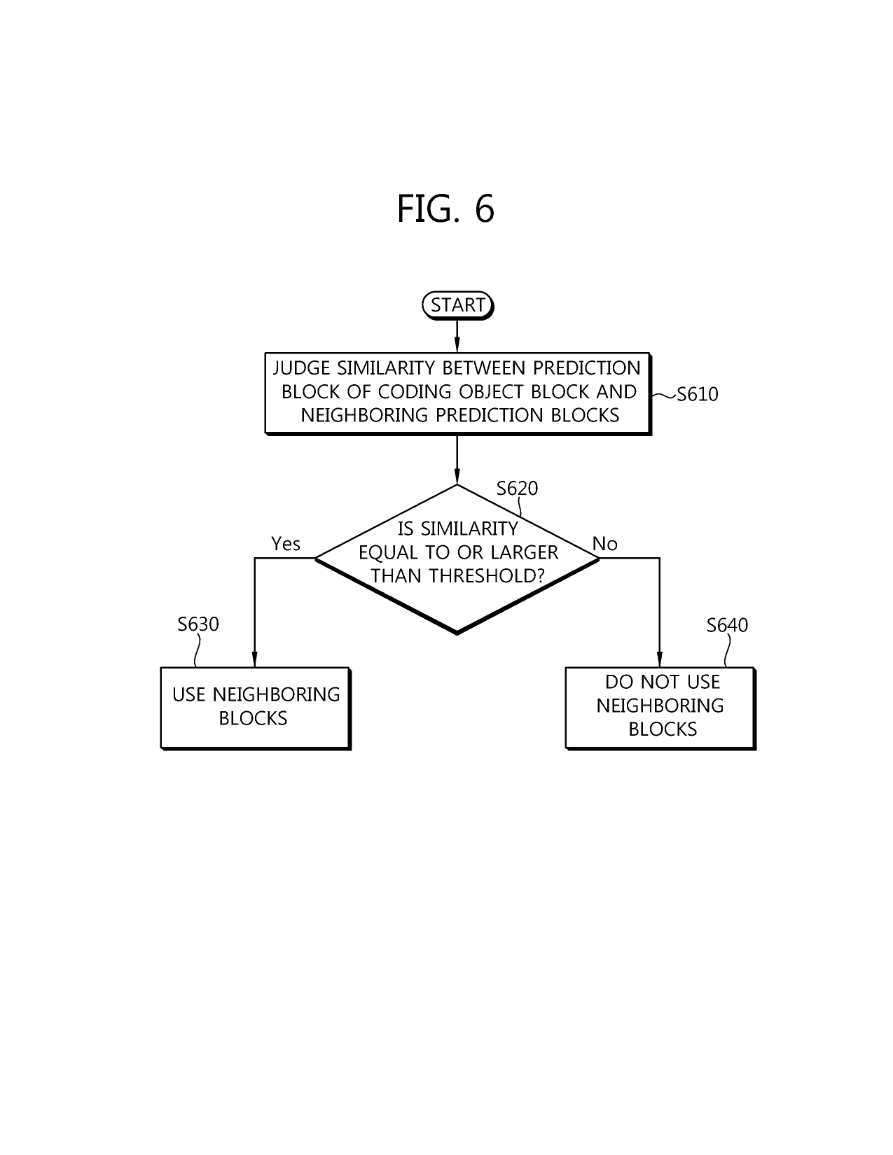

FIG. 6 is a flow chart showing another exemplary embodiment of a method of selecting neighboring blocks used to calculate a filter coefficient. In the exemplary embodiment of FIG. 6, the similarity between a prediction block of a coding object block and neighboring prediction blocks is judged, such that neighboring blocks to be used to calculate a filter coefficient are selected.

Referring to FIG. 6, the coding apparatus judges the similarity between a prediction block of a coding object block and neighboring prediction blocks (S610).

The similarity (D) may be judged by a difference between pixels of the prediction block of the coding object block and pixels of the neighboring prediction blocks, for example, sum of absolute difference (SAD), sum of absolute transformed difference (SATD), sum of squared difference (SSD), or the like. For example, when the SAD is used, the similarity (D) may be represented by the following Equation 1.

$$D = {\sum }_{i = 0}^{N} ( P {c}_{i} - P {n}_{i} ) \qquad 〈 Equation 1 〉$$

Where Pcᵢ means a set of pixels of the prediction block of the coding object block, and Pnᵢ means a set of pixels of the neighboring prediction blocks.

The similarity D may also be judged by the correlation between the pixels of the prediction block of the coding object block and the pixels of the neighboring prediction blocks. Here, the similarity D may be represented by the following Equation 2.

$$D = \frac{{\sum }_{i = 1}^{N} ( P {c}_{i} - E [ P c ] ) ( P {n}_{i} - E [ P n ] )}{( N - 1 ) {S}_{P c} {S}_{P n}} \qquad 〈 Equation 2 〉$$

Where Pcᵢ means a set of pixels of the prediction block of the coding object block, Pnᵢ means a set of pixels of the neighboring prediction blocks, E[Pc] means the average of the set of pixels of the prediction block of the coding object block, and E[Pn] means the average of the set of pixels of the neighboring prediction blocks. In addition, Sp_{c} means a standard deviation of the set of pixels of the prediction block of the coding object block, and Spₙ means a standard deviation of the set of pixels of the neighboring prediction blocks.

Then, the coding apparatus judges whether the similarity is equal to or larger than a threshold (S620). Here, the threshold may be determined by an experiment and the similarity and the determined threshold are compared with each other.

When the similarity between the prediction block of the coding object block and the neighboring prediction blocks is equal to or larger than the threshold, this neighboring block is used to calculate the filter coefficient (S630). When the similarity between the prediction block of the coding object block and the neighboring prediction blocks is less than the threshold, this neighboring block is not used to calculate the filter coefficient (S640).

At least one of a method of selecting all neighboring blocks and a method of selecting neighboring blocks according to the similarity with a prediction block of a current coding object block is used in selecting the neighboring blocks used to calculate the filter coefficient as described above, thereby making it possible to calculate a more accurate filter coefficient capable of reducing a difference signal.

Since the decoding apparatus may also select the neighboring blocks using the same method as the embodiment of FIG. 6, the coding apparatus needs not to separately transmit information on the selected neighboring information to the decoding apparatus. Therefore, the added coding information may be minimized.

Again referring to FIG. 4, the coding apparatus calculates the filter coefficient using the selected neighboring recovery blocks and neighboring prediction blocks (S420).

As an example, a filter coefficient minimizing a mean square error (MSE) between neighboring recovery blocks selected for the coding object block and neighboring prediction blocks corresponding thereto may be selected. Here, the filter coefficient may be calculated by the following Equation 3.

$${c}_{i} = arg min E [ {error}_{k}^{2} ] , \\ {error}_{k} = {\sum }_{i ∈ \{ s \}} {c}_{i} \cdot {p}_{i} - {r}_{k} \qquad 〈 Equation 3 〉$$

Where rₖ indicates a pixel value of the neighboring recovery block of the selected neighboring block, and pᵢ indicates a pixel value of the neighboring prediction block of the selected neighboring block. In addition, cᵢ indicates the filter coefficient, and s indicates a set of filter coefficients.

According to the exemplary embodiment of the present invention, the filter coefficients minimizing the MSE between the neighboring recovery blocks of the coding object block and the prediction blocks corresponding thereto are calculated and used for each prediction block. Therefore, a fixed filter coefficient is not used for all prediction blocks. On the contrary, different filter coefficients are used according to video characteristics of each of the blocks. That is, the filter coefficient may be adaptively calculated and used according to the prediction block. Therefore, the accuracy of the prediction block may be improved, and the difference signal is reduced, such that coding performance may be improved.

The filter coefficient may be calculated using a 1-dimensional (1D) separation type filter or a 2-dimensional (2D) non-separation type filter.

Since the decoding apparatus may calculate the filter coefficient using the same method as the coding apparatus, the coding apparatus needs not to separately code and transmit filter coefficient information. Therefore, the added coding information may be minimized.

Again referring to FIG. 4, the coding apparatus determines whether or not filtering is performed on the prediction block of the current coding object block (S430). When it is determined that the filtering is performed, the filtering is performed on the prediction block, and when it is determined that the filtering is not performed, the next operation may be performed without the filtering on the prediction block.

As an example of determining whether or not the filtering is performed, a determination that the filtering is always performed on the prediction block of the current coding object block may be made. This is to determine a pixel value of a prediction block used to calculate a residual block through rate-distortion cost comparison between a filtered prediction block and a non-filtered prediction block. The residual block means a block generated by a difference between an original block and a prediction block, and the original block means an input intact block that is not subjected to a coding process within a current coding object picture.

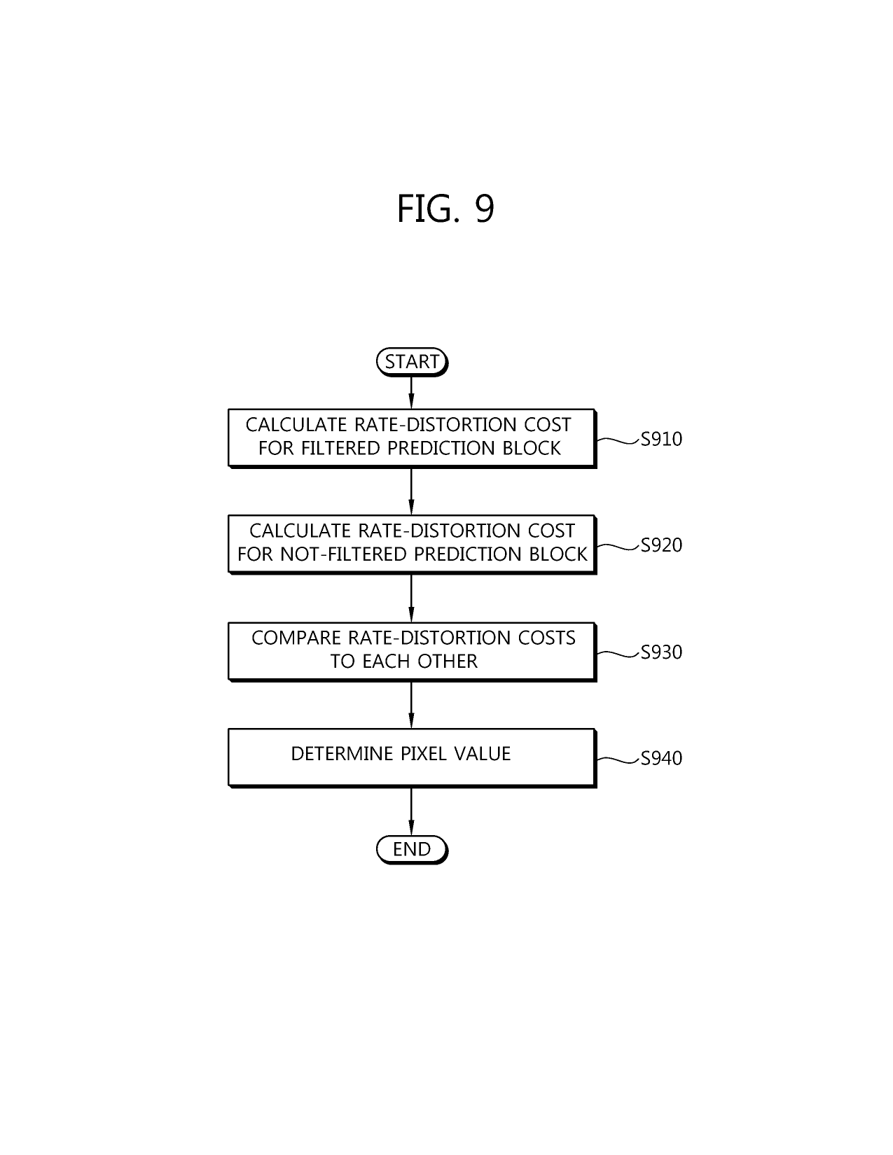

That is, in order to determine the pixel value of the prediction block of the current coding object block through the rate-distortion cost comparison, a determination may be made so that the filtering is always performed on the prediction block of the current coding object block. A method of determining a pixel value through the rate-distortion cost comparison will be described in detail in FIG. 9.

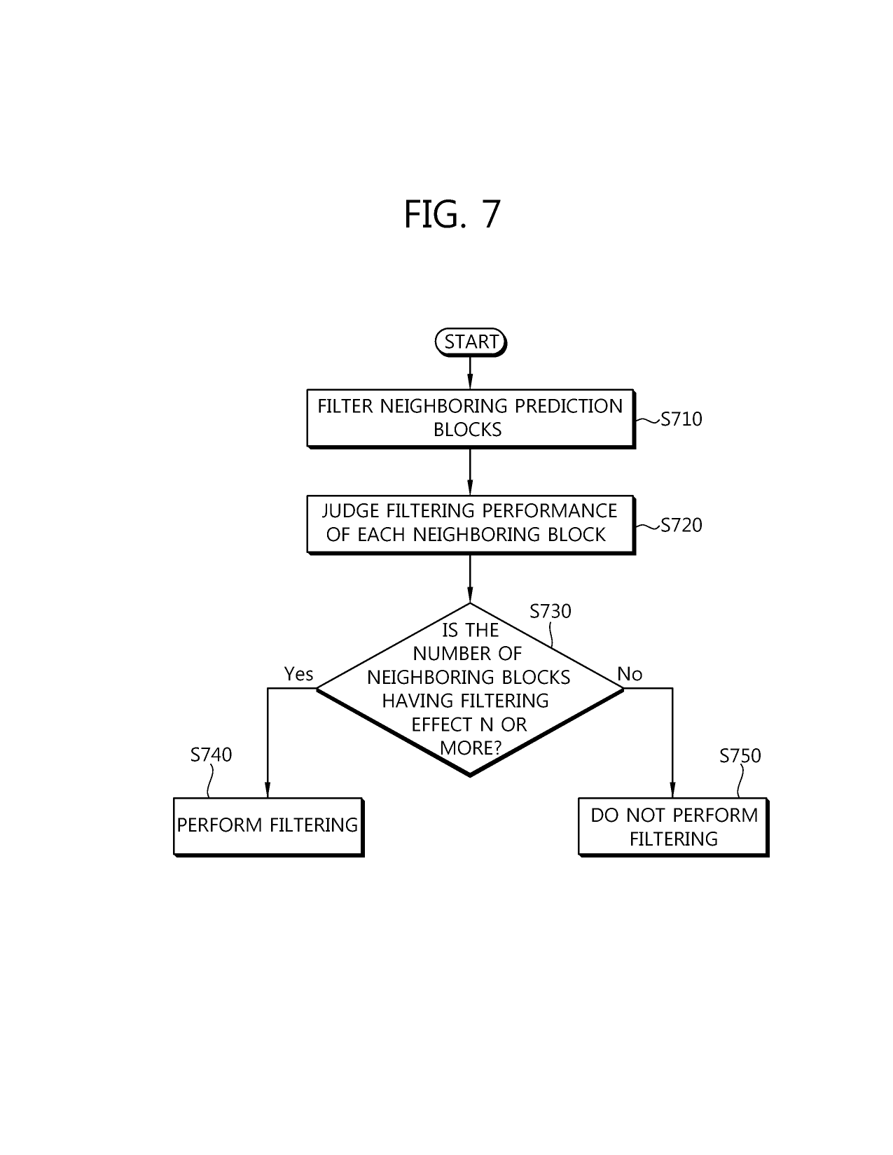

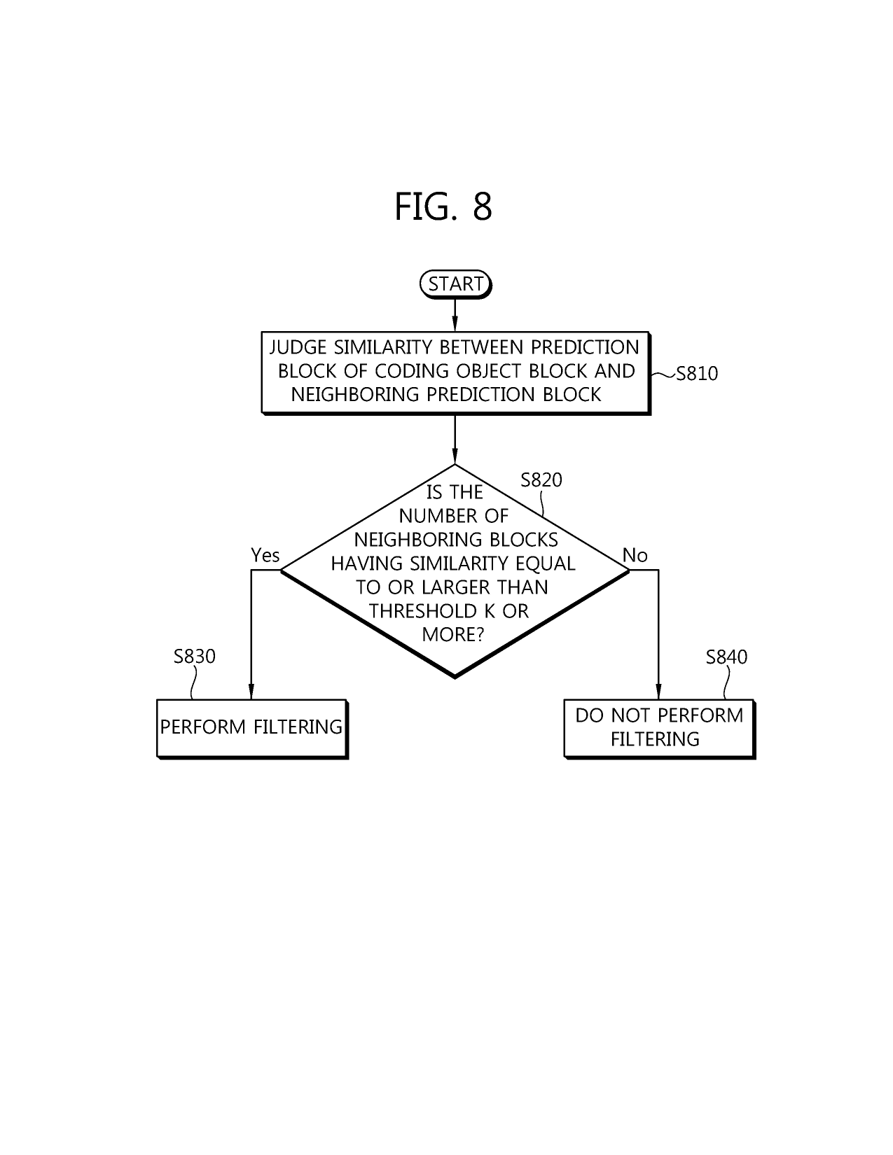

As another example of determining whether or not the filtering is performed, whether or not the filtering is performed on the prediction block of the current coding object block may be determined using characteristic information between the prediction block of the current coding object block and the neighboring blocks. This will be described in detail in exemplary embodiments of FIGS. 7 and 8.

FIG. 7 is a flow chart showing an exemplary embodiment of a method of determining whether or not filtering is performed by judging filtering performance.

Referring to FIG. 7, the coding apparatus filters each of neighboring prediction blocks using a filter coefficient (S710). For example, when neighboring blocks A, B, C, and D are selected, each of prediction blocks of the neighboring blocks A, B, C, and D is filtered using the filter coefficient obtained in the operation of calculating the filter coefficient.

Then, the coding apparatus judges filtering performance of each neighboring block (S720).

As an example, with respect to each neighboring block, an error between neighboring prediction blocks on which filtering is not performed and neighboring recovery blocks may be compared with an error between neighboring prediction blocks on which filtering is performed and neighboring recovery blocks. Each of the errors may be calculated using SAD, SATD, or SSD.

A case in which the filtering is performed on the neighboring prediction blocks and a case in which the filtering is not performed on the neighboring prediction blocks are compared with each other, whereby it may be judged that performance is relatively more excellent in the case in which a relatively smaller error occurs. That is, when the error between the neighboring prediction blocks on which the filtering is performed and the neighboring recovery blocks is smaller than the error between the neighboring prediction blocks on which the filtering is not performed and the neighboring recovery blocks, it may be judged that there is a filtering effect.

The coding apparatus may judge whether the number of neighboring blocks having the filtering effect is N or more by comparing the error in the case in which the filtering is performed on each neighboring prediction block with the error in the case in which the filtering is not performed on each neighboring prediction block.

When the number of neighboring blocks having the filtering effect is N or more, it is determined that the filtering is performed (S740), and when the number of neighboring blocks having the filtering effect is less than N, it is determined that the filtering is not performed (S750). Here, N may be a value determined by an experiment.

FIG. 8 is a flow chart showing an exemplary embodiment of a method of determining whether or not filtering is performed by judging the similarity between a prediction block of a coding object block and neighboring prediction blocks.

Referring to FIG. 8, the coding apparatus judges the similarity between a prediction block of a coding object block and neighboring prediction blocks (S810).

The similarity may be judged by SAD, SATD, SSD, or the like, between pixels of the prediction block of the coding object block and pixels of the neighboring blocks. For example, the judgment of the similarity using the SAD may be represented by the following Equation 4.

$$D = {\sum }_{i = 0}^{N} ( P {c}_{i} - P {n}_{i} ) \qquad 〈 Equation 4 〉$$

Where Pcᵢ means a set of pixels of the prediction block of the coding object block, and Pnᵢ means a set of pixels of the neighboring prediction blocks.

The similarity may also be judged by the correlation between the pixels of the prediction block of the coding object block and the pixels of the neighboring prediction blocks.

After the similarity is judged, the coding apparatus judges whether the number of neighboring blocks having the similarity equal to or larger than a threshold is K or more (S820). When the number of neighboring blocks having the similarity equal to or larger than the threshold is K or more, it is determined that the filtering is performed (S830), and when the number of neighboring blocks having the similarity equal to or larger than the threshold is less than K, it is determined that the filtering is not performed (S840). Here, each of the threshold and K may be a value determined by an experiment.

Whether or not the filtering is performed may be determined by using at least one of the methods according to the exemplary embodiment of FIGS. 7 and 8 for each prediction block of each current coding object block. Therefore, since whether or not the filtering is performed may be adaptively determined by judging the similarity or the filtering performance of the neighboring prediction block for each prediction block, the coding performance may be improved.

The determination on whether or not the filtering is performed using the prediction block of the current coding object block and the characteristic information between the neighboring blocks may also be similarly performed in the decoding apparatus. Therefore, the coding apparatus needs not to separately code or transmit information on whether or not the filtering is performed. As a result, the added coding information may be minimized.

Again referring to FIG. 4, the coding apparatus performs the filtering on the prediction block of the current coding object block (S440). However, the filtering on the prediction block is performed when it is determined that the filtering is performed in the operation (S430) of determining whether or not the filtering is performed.

The prediction block of the current coding object block may be filtered using the filter coefficient calculated in the operation of calculating the filter coefficient. The filtering on the prediction block may be represented by the following Equation 5.

$${p}_{i}^{′} = {\sum }_{i ∈ \{ s \}} {c}_{i} \cdot {p}_{i} \qquad 〈 Equation 5 〉$$

Where pᵢ′ means a pixel value of the filtered prediction block of the coding object block, pᵢ means a pixel value of the prediction block of the coding object block before being filtered, cᵢ means the filter coefficient, and s means a set of filter coefficients.

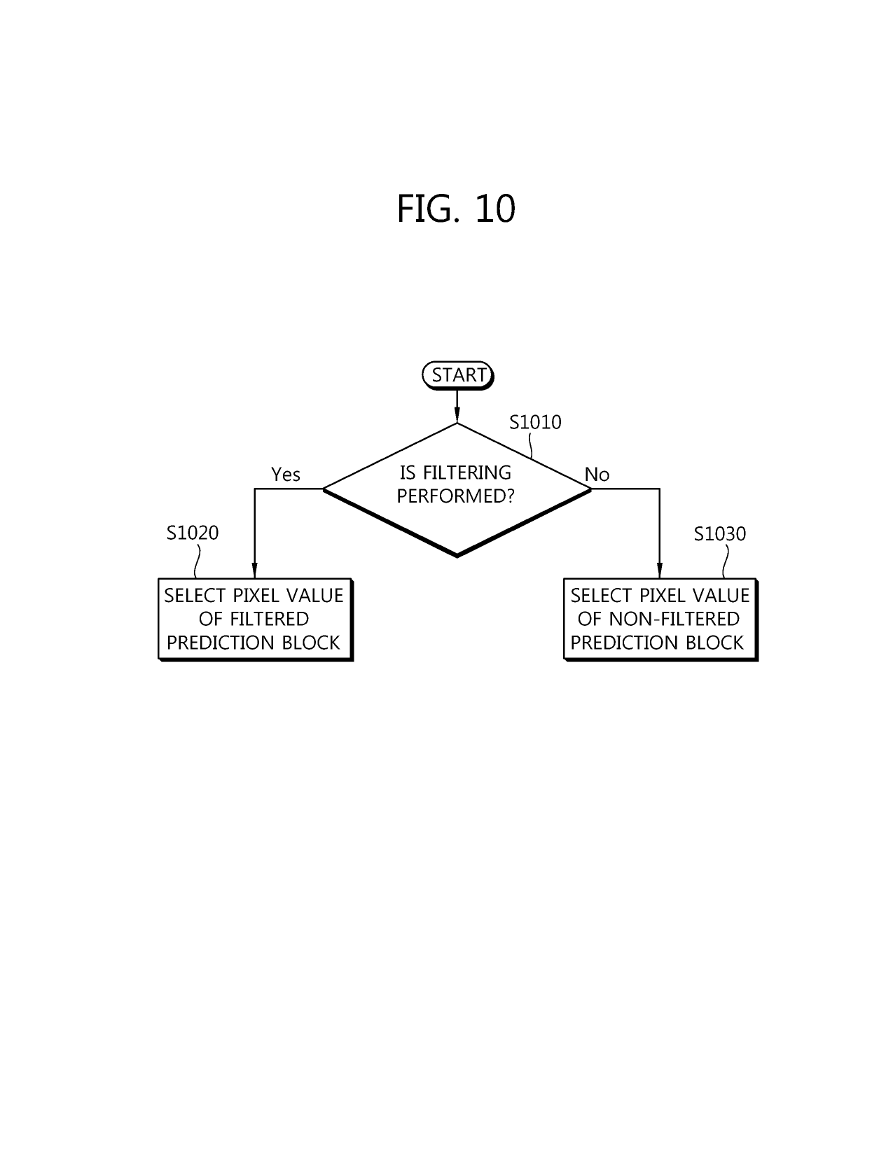

Then, the coding apparatus determines a pixel value of the prediction block of the current coding object block (S450). The pixel value may be used to calculate the residual block, which is a block generated by a difference between the original block and the prediction block. A method of determining the pixel value will be described in detail through exemplary embodiments of FIGS. 9 and 10.

FIG. 9 is a flow chart showing an exemplary embodiment of a method of determining a pixel value of a prediction block of a current coding object block. According to FIG. 9, the pixel value may be determined by comparing rate-distortion cost values between a prediction block before being filtered and a filtered prediction block with each other.

Referring to FIG. 9, the coding apparatus calculates a rate-distortion cost value for the filtered prediction block of the current coding object block. The calculation of the rate-distortion cost may be represented by the following Equation 6.

J_{f}=D_{f}+λ·R_{f} <Equation 6>

Where J_{f} means a rate-distortion (a bit rate-distortion) cost value for the filtered prediction block of the current coding object block, D_{f} means an error between the original block and the filtered prediction block, λ means a Lagrangian coefficient, and R_{f} means the number of bits generated after coding (including a flag on whether or not the filtering is performed).

Then, the coding apparatus calculates a rate-distortion cost value for the non-filtered prediction block of the current coding object block (S920). The calculation of the rate-distortion cost may be represented by the following Equation 7.

J_{nf}=D_{nf}+λ·R_{nf} <Equation 7>

Where J_{nf} means a rate-distortion (a bit rate-distortion) cost value for the non-filtered prediction block of the current coding object block, D_{nf} means an error between the original block and the non-filtered prediction block, λ means a Lagrangian coefficient, and R_{nf} means the number of bits generated after coding (including a flag on whether or not the filtering is performed).

After the rate-distortion cost values are calculated, the coding apparatus compares the rate-distortion cost values with each other (S930). Then, the coding apparatus determines the pixel values for the final prediction block of the current coding object block based on results of the comparison (S940). Here, the pixel value in the case of having a minimal rate-distortion cost value may be determined as a pixel value for the final prediction block.

As described above in the operation (S430) of determining whether or not the filtering is performed in FIG. 4, when the pixel value of the final prediction block is determined by the comparison of the rate-distortion cost values, the filtering may always be performed in order to calculate the rate-distortion value. However, according to results of the comparison of the rate-distortion costs, a pixel value of the prediction block before being filtered as well as the pixel value of the filtered prediction block may be determined as the pixel value for the final prediction block.

In the method of determining a pixel value of FIG. 9, the coding apparatus needs to transmit information informing whether or not the filtering is performed to the decoding apparatus. That is, information on whether the pixel value of the prediction block before being filtered or the pixel value of the filtered prediction block is used is transmitted to the decoding apparatus. The reason is that a process of determining a pixel value through the rate-distortion cost comparison may not be similarly performed in the decoding apparatus since the decoding apparatus does not have information on an original block.

FIG. 10 is a flow chart showing another exemplary embodiment of a method of determining a pixel value of a prediction block of a current coding object block.

In the exemplary embodiment of FIG. 10, the pixel value of the final prediction block is selected by determining whether or not the filtering is performed based on the characteristic information between the prediction block of the current coding object block and the neighboring blocks. The method of determining whether or not the filtering is performed using the characteristic information between the prediction block of the current coding object block and the neighboring blocks has been described with reference to FIGS. 7 and 8.

Referring to FIG. 10, the coding apparatus judges whether the filtering is performed on the prediction block of the current coding object block (S1010). Information on whether or not the filtering is performed is information determined according to the characteristic information between the prediction block of the current coding object block and the neighboring blocks.

When the filtering is performed on the prediction block, it is determined that the pixel value of the filtered prediction block is the pixel value of the final prediction block (S 1020). When the filtering is not performed on the prediction block, it is determined that the pixel value of the non-filtered prediction block is the pixel value of the final prediction block (S 1030).

The determination on whether or not the filtering is performed using the prediction block of the current coding object block and the characteristic information between the neighboring blocks may also be similarly performed in the decoding apparatus. Therefore, the coding apparatus needs not to separately code and transmit the information on whether or not the filtering is performed.

In determining the pixel value of the final prediction block, at least one of the methods according to the exemplary embodiments of FIGS. 9 and 10 may be used. In the exemplary embodiment of FIG. 10, when the filtering is performed on the prediction block according to the characteristic information between the prediction block of the current coding object block and the neighboring blocks, the pixel value of the final prediction block may be additionally determined by the exemplary embodiment of FIG. 9. In this case, as described in the exemplary embodiment of FIG. 9, the coding apparatus needs to transmit the information informing whether or not the filtering is performed to the decoding apparatus.

The coding apparatus may generate the residual block using the original block and the final prediction block of which the pixel value is determined (S460). As an example, the residual block may be generated by a difference between the final prediction block and the original block. The residual block may be coded and transmitted to the decoding apparatus. When the present invention is applied to the video coding apparatus according to the exemplary embodiment of FIG. 1, the subtracter 125 may generate the residual block by the difference between the final prediction block and the original block, and the residual block may be coded while penetrating through the transformer 130, the quantizer 140, and the entropy-coder 150.

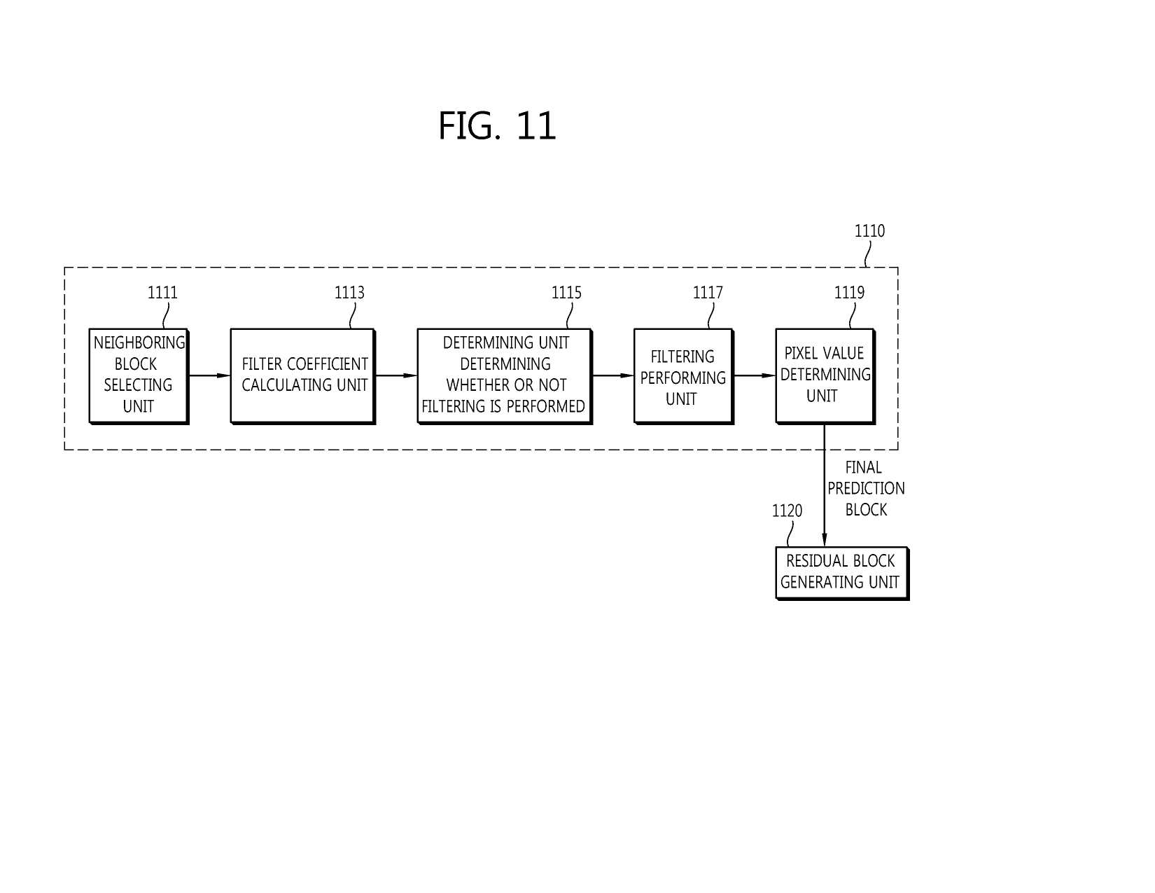

FIG. 11 is a block diagram schematically showing a configuration according to an exemplary embodiment of a prediction block filtering device applied to the video coding apparatus. In the exemplary embodiment of FIG. 11, a detailed description of components or methods that are substantially the same as the components or methods described above with reference to FIGS. 4 to 10 will be omitted.

Referring to FIG. 11, FIG. 11 includes a prediction block filtering device 1110 and a residual block generating unit 1120. The prediction block filtering device 1110 may include a neighboring block selecting unit 1111, a filter coefficient calculating unit 1113, a determining unit 1115 determining whether or not filtering is performed, a filtering performing unit 1117, and a pixel value determining unit 1119.

The prediction block filtering device 1110 may use the prediction block, the original block, or the neighboring blocks of the current coding object block in performing the filtering on the prediction block.

The prediction block of the current coding object block may be a prediction block generated in the motion compensator 112 or the intra predictor 120 according to the exemplary embodiment of FIG. 1. In the case, the generated prediction block is not directly input but the final prediction block filtered through the prediction block filtering device 1110 may be input, to the subtracter 125. Therefore, the subtracter 125 may perform subtraction between the filtered final prediction block and the original block.

The neighboring block may be a block stored in the reference picture buffer 190 according to the exemplary embodiment of FIG. 1 or a separate memory. In addition, a neighboring recovery block or a neighboring prediction block generated during a video coding process may also be used as the neighboring block as it is.

The neighboring block selecting unit 1111 may select the neighboring blocks used to calculate the filter coefficient.

As an example, the neighboring block selecting unit 1111 may select all neighboring recovery blocks adjacent to the coding object block and prediction blocks corresponding thereto as the neighboring blocks for calculating the filter coefficient. Here, the neighboring block selecting unit 1111 may select all pixel value areas of the adjacent neighboring blocks or only some pixel value areas within the adjacent neighboring blocks.

As another example, the neighboring block selecting unit 1111 may select only neighboring prediction blocks associated with the prediction block of the current coding object block among possible neighboring blocks and neighboring recovery blocks corresponding thereto. For example, the neighboring block selecting unit 1111 may judge the similarity between the prediction block of the coding object block and the neighboring prediction block and then select the neighboring blocks used to calculate the filter coefficient using the similarity.

The filter coefficient calculating unit 1113 may calculate the filter coefficient using the selected neighboring recovery blocks and neighboring prediction blocks. As an example, the filter coefficient calculating unit 1113 may select the filter coefficient minimizing the MSE between the neighboring recovery blocks selected for the coding object block and the neighboring prediction blocks corresponding thereto.

The determining unit 1115 determining whether or not filtering is performed may determine whether or not the filtering is performed on the prediction block of the current coding object block.

As an example, the determining unit 1115 determining whether or not filtering is performed may make a determination that the filtering is always performed on the prediction block of the current coding object block. This is to determine the pixel value of the prediction block used to calculate the residual block through the rate-distortion cost comparison between the filtered prediction block and the non-filtered prediction block.

As another example, the determining unit 1115 determining whether or not filtering is performed may determine whether or not the filtering is performed on the prediction block of the current coding object block using the characteristic information between the prediction block of the current coding object block and the neighboring blocks. As an example, the determining unit 1115 determining whether or not filtering is performed may determine whether or not the filtering is performed by judging the filtering performance of the neighboring blocks. As another example, the determining unit 1115 determining whether or not filtering is performed may also determine whether or not the filtering is performed by judging the similarity between the prediction block of the coding object block and the neighboring prediction blocks.

The filtering performing unit 1117 may perform the filtering on the prediction block of the current coding object block. Here, the filtering performing unit 1117 may perform the filtering using the filter coefficient calculated in the filter coefficient calculating unit 1113.

The pixel value determining unit 1119 may determine the pixel value of the prediction block of the current coding object block.

As an example, the pixel value determining unit 1119 may determine the pixel value by comparing the rate-distortion cost values between the prediction block before being filtered and the filtered prediction block with each other. As another example, the pixel value determining unit 1119 may determine the pixel value of the final prediction block using determination results on whether or not the filtering is performed based on the characteristic information between the prediction block of the current coding object block and the neighboring blocks.

The residual block generating unit 1120 may generate the residual block using the determined final prediction block and the original block of the current coding object block. For example, the residual block generating unit 1120 may generate the residual block by the difference between the final prediction block and the original block. The residual block generating unit 1120 may correspond to the subtracter 125 according to the exemplary embodiment of FIG. 1.

With the video coding apparatus and method according to the exemplary embodiment of the present invention, the filter coefficients adaptively calculated for each prediction block of each coding object block rather than the fixed filter coefficient are used. In addition, whether or not the filtering is performed on the prediction block of each coding object block may be adaptively selected. Therefore, the accuracy of the prediction picture is improved, such that the difference signal is minimized, thereby improving the coding performance.

Since the filter coefficient may also be similarly calculated in the decoding apparatus, the coding information may be minimized. The information on whether or not the filtering is performed may be coded and transmitted to the decoding apparatus. Alternatively, the decoding apparatus may determine whether or not the filtering is performed using the relationship with the neighboring blocks.

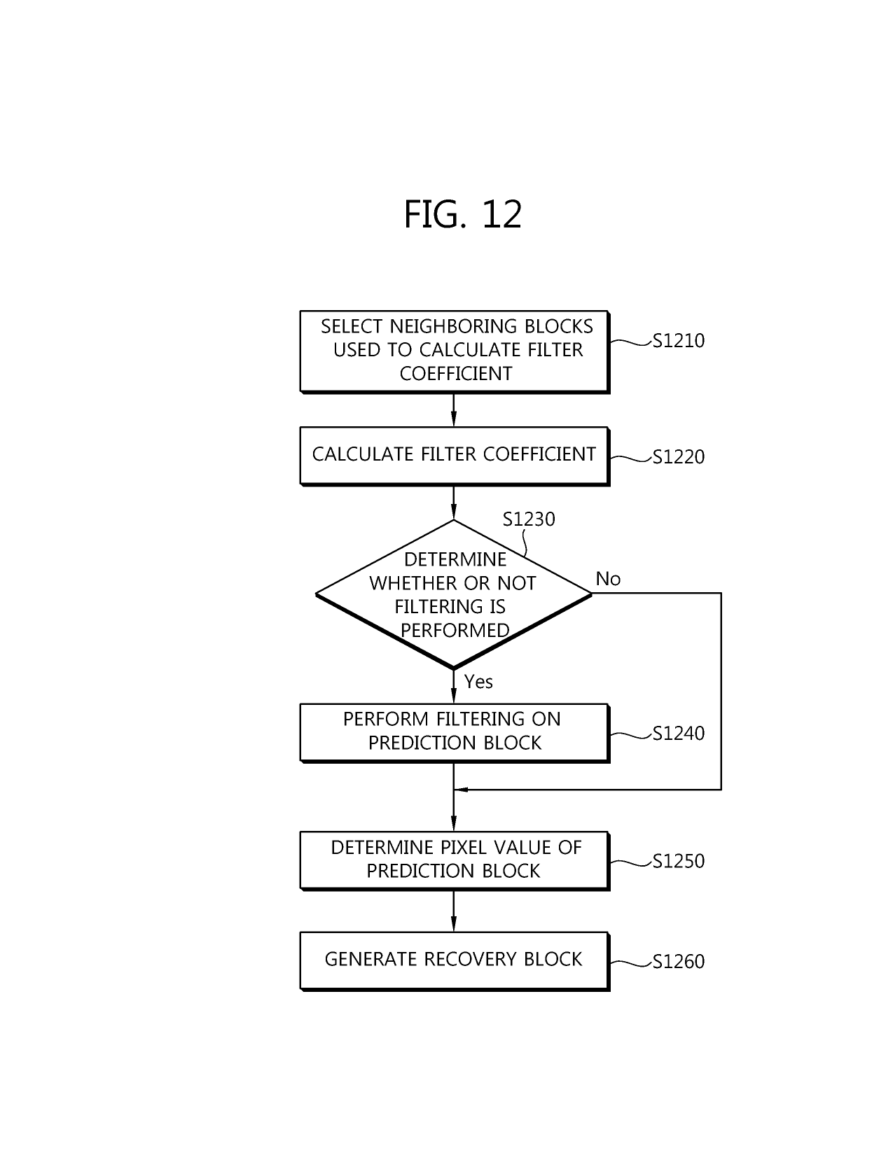

FIG. 12 is a flow chart schematically showing a video decoding method using prediction block filtering according to an exemplary embodiment of the present invention. Filtering on a prediction block of a current decoding object block may be used in decoding the picture. According to the exemplary embodiment of the present invention, the picture is decoded using the prediction block filtering.

In the prediction block filtering, the prediction block of the current decoding object block or neighboring blocks may be used.

The prediction block of the current decoding object block may be a prediction block generated in the intra predictor 240 or the motion compensator 250 according to the exemplary embodiment of FIG. 2. In this case, after a prediction block filter process is performed on the prediction block generated in the intra predictor 240 or the motion compensator 250, the adder 255 may add a recovered residual block to the filtered final prediction block.

The neighboring block may be a block stored in the reference picture buffer 270 according to the exemplary embodiment of FIG. 2 or a separate memory. In addition, a neighboring recovery block or a neighboring prediction block generated during a video decoding process may also be used as the neighboring block as it is.

Hereinafter, in describing a video decoding method according to exemplary embodiments of FIGS. 12 to 15, a detailed description of components, methods, and effects that are substantially the same as the components, methods, and effects described above in the video coding method according to the exemplary embodiments of FIGS. 4 to 10 will be omitted.

Referring to FIG. 12, the decoding apparatus selects neighboring blocks used to calculate a filter coefficient (S 1210). The neighboring blocks may be used to calculate the filter coefficient. In this case, which block of the neighboring blocks is used may be judged.

As an example, all neighboring recovery blocks adjacent to the decoding object block and all neighboring prediction blocks corresponding to the neighboring recovery blocks may be selected as neighboring blocks for calculating the filter coefficient and be used for decoding. A set of pixel values of the neighboring blocks used to calculate the filter coefficient may be variously selected.

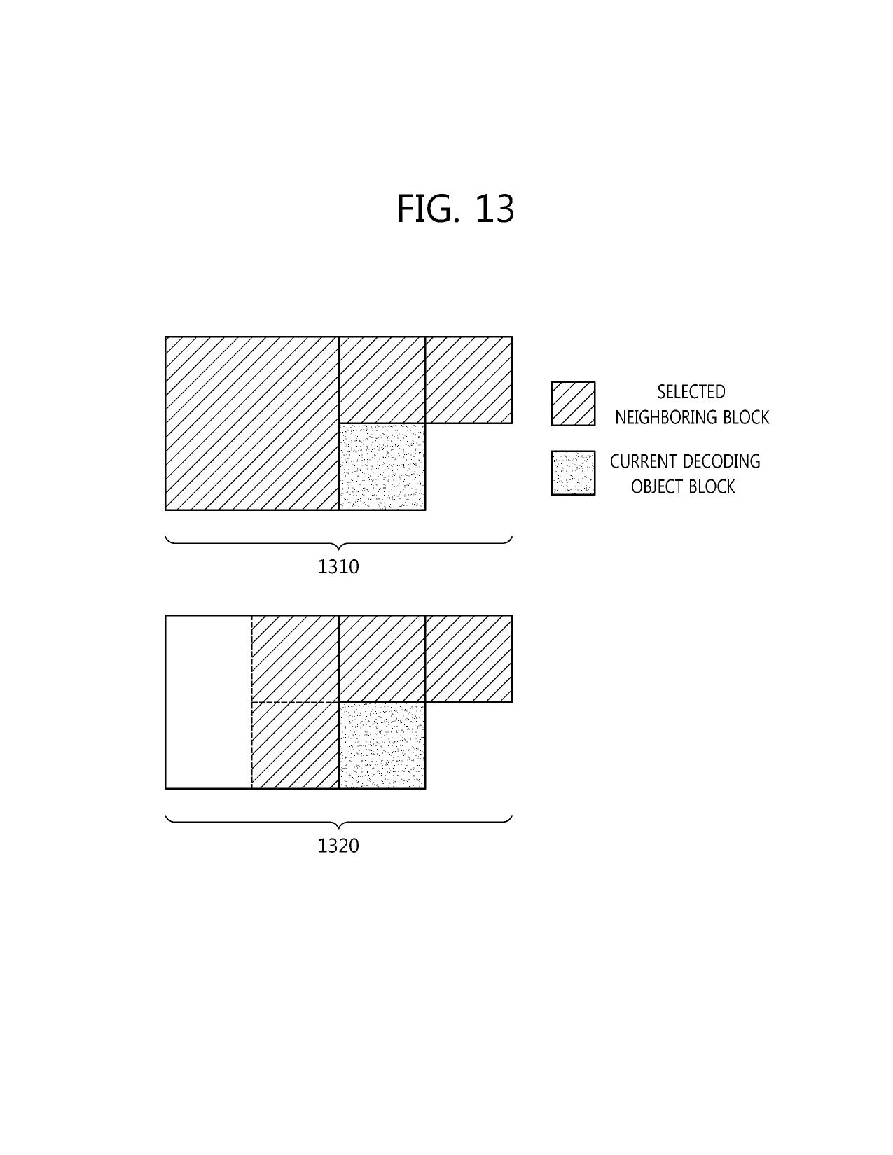

FIG. 13 is a conceptual diagram showing an exemplary embodiment of a method of selecting neighboring blocks used to calculate a filter coefficient. All pixel value areas of adjacent neighboring blocks may be used to calculate the filter coefficient, as shown in an upper portion 1310 of FIG. 13. However, only some pixel value areas within adjacent neighboring blocks may also be used to calculate the filter coefficient as shown in a lower portion 1320 of FIG. 5.

As another example, only neighboring prediction blocks associated with a prediction block of a current decoding object block among possible neighboring blocks and neighboring recovery blocks corresponding thereto may be used.

For example, the neighboring blocks to be used to calculate the filter coefficient may be selected by judging the similarity between the prediction block of the decoding object block and the neighboring prediction blocks.

The similarity (D) may be judged by a difference between pixels of the prediction block of the decoding object block and pixels of the neighboring prediction blocks, for example, SAD, SATD, SSD, or the like. For example, when the SAD is used, the similarity (D) may be represented by the following Equation 8.

$$D = {\sum }_{i = 0}^{N} ( P {c}_{i} - P {n}_{i} ) \qquad 〈 Equation 8 〉$$

Where Pcᵢ means a set of pixels of the prediction block of the decoding object block, and Pnᵢ means a set of pixels of the neighboring prediction blocks.

The similarity D may also be judged by the correlation between the pixels of the prediction block of the decoding object block and the pixels of the neighboring prediction blocks. Here, the similarity D may be represented by the following Equation 9.

$$D = \frac{{\sum }_{i = 1}^{N} ( P {c}_{i} - E [ P c ] ) ( P {n}_{i} - E [ P n ] )}{( N - 1 ) {S}_{P c} {S}_{P n}} \qquad 〈 Equation 9 〉$$

Here, Pcᵢ means a set of pixels of the prediction block of the decoding object block, Pnᵢ means a set of pixels of the neighboring prediction blocks, E[Pc] means the average of the set of pixels of the prediction block of the decoding object block, and E[Pn] means the average of the set of pixels of the neighboring prediction blocks. In addition, Sp_{c} means a standard deviation of the set of pixels of the prediction block of the decoding object block, and Spₙ means a standard deviation of the set of pixels of the neighboring prediction blocks.

When the similarity is equal to or larger than a threshold, this neighboring block may be used to calculate the filter coefficient. Here, the threshold may be determined by an experiment.

Again referring to FIG. 12, the decoding apparatus calculates the filter coefficient using the selected neighboring recovery blocks and neighboring prediction blocks (S1220).

As an example, a filter coefficient minimizing a mean square error (MSE) between neighboring recovery blocks selected for the decoding object block and neighboring prediction blocks corresponding thereto may be selected. Here, the filter coefficient may be calculated by the following Equation 10.

$${c}_{i} = arg min E [ {error}_{k}^{2} ] , \\ {error}_{k} = {\sum }_{i ∈ \{ s \}} {c}_{i} \cdot {p}_{i} - {r}_{k} \qquad 〈 Equation 10 〉$$

Where rₖ indicates a pixel value of the neighboring recovery block of the selected neighboring block, and pᵢ indicates a pixel value of the neighboring prediction block of the selected neighboring block. In addition, cᵢ indicates the filter coefficient, and s indicates a set of filter coefficients.

The filter coefficient may be calculated using a 1-dimensional (1D) separation type filter or a 2-dimensional (2D) non-separation type filter.

Again referring to FIG. 12, the decoding apparatus determines whether or not filtering is performed on the prediction block of the current decoding object block (S1230). When it is determined that the filtering is performed, the filtering is performed on the prediction block, and when it is determined that the filtering is not performed, the next operation may performed without the filtering on the prediction block.

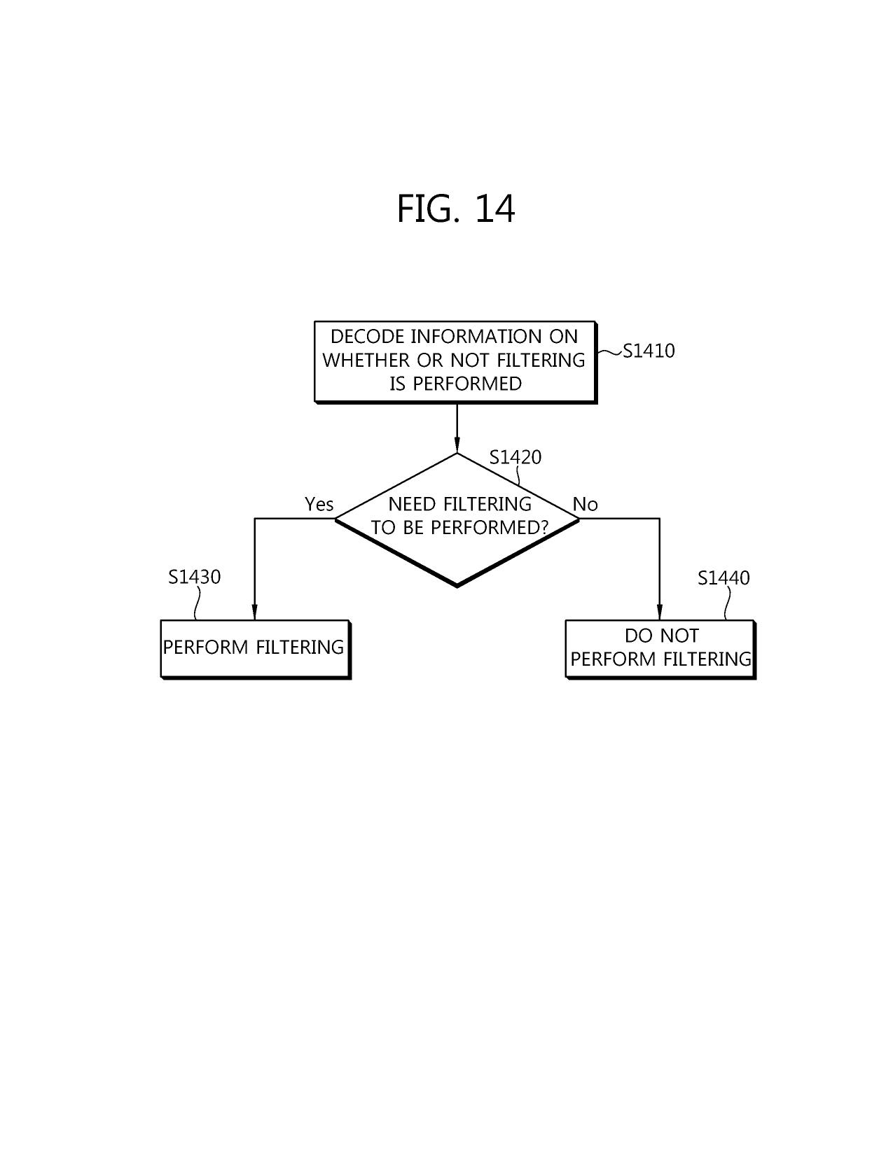

As an example of determining whether or not the filtering is performed, when information on whether or not the filtering is performed is transmitted from the coding apparatus to the decoding apparatus, the decoding apparatus may determine whether or not the filtering is performed using the decoded information on whether or not the filtering is performed. This will be described in detail through an exemplary embodiment of FIG. 14.

FIG. 14 is a flow chart showing an exemplary embodiment of a method of determining whether or not filtering is performed using information on whether or not filtering is performed.

Referring to FIG. 14, the decoding apparatus decodes information on whether or not filtering is performed (S1410). According to the exemplary embodiment of FIG. 9 described above, the video coding apparatus may determine the pixel value of the prediction block by comparing the rate-distortion cost values between the prediction block before being filtered and the filtered prediction block with each other. Here, the coding apparatus needs to transmit information informing whether or not the filtering is performed to the decoding apparatus. The information on whether or not the filtering is performed may be coded in the coding apparatus, formed as a compressed bit stream, and then transmitted from the coding apparatus to the decoding apparatus. Since the decoding apparatus receives the coded information on whether or not the filtering is performed, it may decode the coded information.

The decoding apparatus judges whether or not the filtering needs to be performed using the decoded information on whether or not the filtering is performed (S1420). When the filtering is performed in the coding apparatus, that is, when the pixel value of the filtered prediction block is used as the pixel value of the final prediction block of the coding apparatus, the decoding apparatus makes a determination that the filtering is performed on the prediction block of the decoding object block (S1430). When the filtering is not performed in the coding apparatus, that is, when the pixel value of the prediction block before being filtered is used as the pixel value of the final prediction block of the coding apparatus, the decoding apparatus makes a determination that the filtering is not performed on the prediction block of the decoding object block (S 1440).

As another example of determining whether or not the filtering is performed, the decoding apparatus may determine whether or not the filtering is performed on the prediction block of the current coding object block using characteristic information between the prediction block of the current coding object block and the neighboring blocks.

For example, the decoding apparatus may determine whether or not the filtering is performed by judging filtering performance of the neighboring blocks.

Here, the decoding apparatus filters each of the neighboring prediction blocks using the filter coefficient. For example, when neighboring blocks A, B, C, and D are selected, each of prediction blocks of the neighboring blocks A, B, C, and D may be filtered using the filter coefficient obtained in the operation of calculating the filter coefficient. Then, the decoding apparatus judges filtering performance of each neighboring block. As an example, with respect to each neighboring block, an error between neighboring prediction blocks on which filtering is not performed and neighboring recovery blocks may be compared with an error between neighboring prediction blocks on which filtering is performed and neighboring recovery blocks. Each of the errors may be calculated using SAD, SATD, and SSD.

When the error between the neighboring prediction blocks on which the filtering is performed and the neighboring recovery blocks is smaller than the error between the neighboring prediction blocks on which the filtering is not performed and the neighboring recovery blocks, it may be judged that there is a filtering effect. As a result of comparison between the error in the case in which the filtering is performed on each neighboring prediction block and the error in the case in which the filtering is not performed on each neighboring prediction block, when the number of neighboring blocks having the filtering effect is N or more, it is determined that the filtering is performed. Otherwise, it is determined that the filtering is not performed. Here, N may be a value determined by an experiment.

As another example, whether or not the filtering is performed may be determined by judging the similarity between the prediction block of the decoding object block and the neighboring prediction blocks.

The decoding apparatus may calculate the similarity between the prediction block of the decoding object block and the neighboring prediction block. The similarity may be judged by SAD, SATD, SSD, or the like, between the pixels of the prediction block of the coding object block and the pixels of the neighboring blocks. For example, the judgment of the similarity using the SAD may be represented by the following Equation 11.

$$D = {\sum }_{i = 0}^{N} ( P {c}_{i} - P {n}_{i} ) \qquad 〈 Equation 11 〉$$

Where Pcᵢ means a set of pixels of the prediction block of the decoding object block, and Pnᵢ means a set of pixels of the neighboring prediction blocks.

The similarity may also be judged by the correlation between the pixels of the prediction block of the decoding object block and the pixels of the neighboring prediction blocks.

When the number of neighboring blocks having the similarity equal to or larger than the threshold is K or more, it is determined that the filtering is performed on the prediction block of the decoding object block. Otherwise, it is determined that the filtering is not performed thereon. Here, each of the threshold and K may be a value determined by an experiment.

Again referring to FIG. 12, the decoding apparatus performs the filtering on the prediction block of the current decoding object block (S1240). However, the filtering on the prediction block is performed when it is determined that the filtering is performed in the operation (S1230) of determining whether or not the filtering is performed.

The prediction block of the current decoding object block may be filtered using the filter coefficient calculated in the operation of calculating the filter coefficient. The filtering on the prediction block may be represented by the following Equation 12.

$${p}_{i}^{′} = {\sum }_{i ∈ \{ s \}} {c}_{i} \cdot {p}_{i} \qquad 〈 Equation 12 〉$$

Where pᵢ′ means a pixel value of the filtered prediction block of the decoding object block, pᵢ means a pixel value of the prediction block of the decoding object block before being filtered, cᵢ means the filter coefficient, and s means a set of filter coefficients.

Then, the decoding apparatus determines a pixel value of the prediction block of the current decoding object block (S1250). The pixel value may be used to calculate the recovery block of the decoding object block.

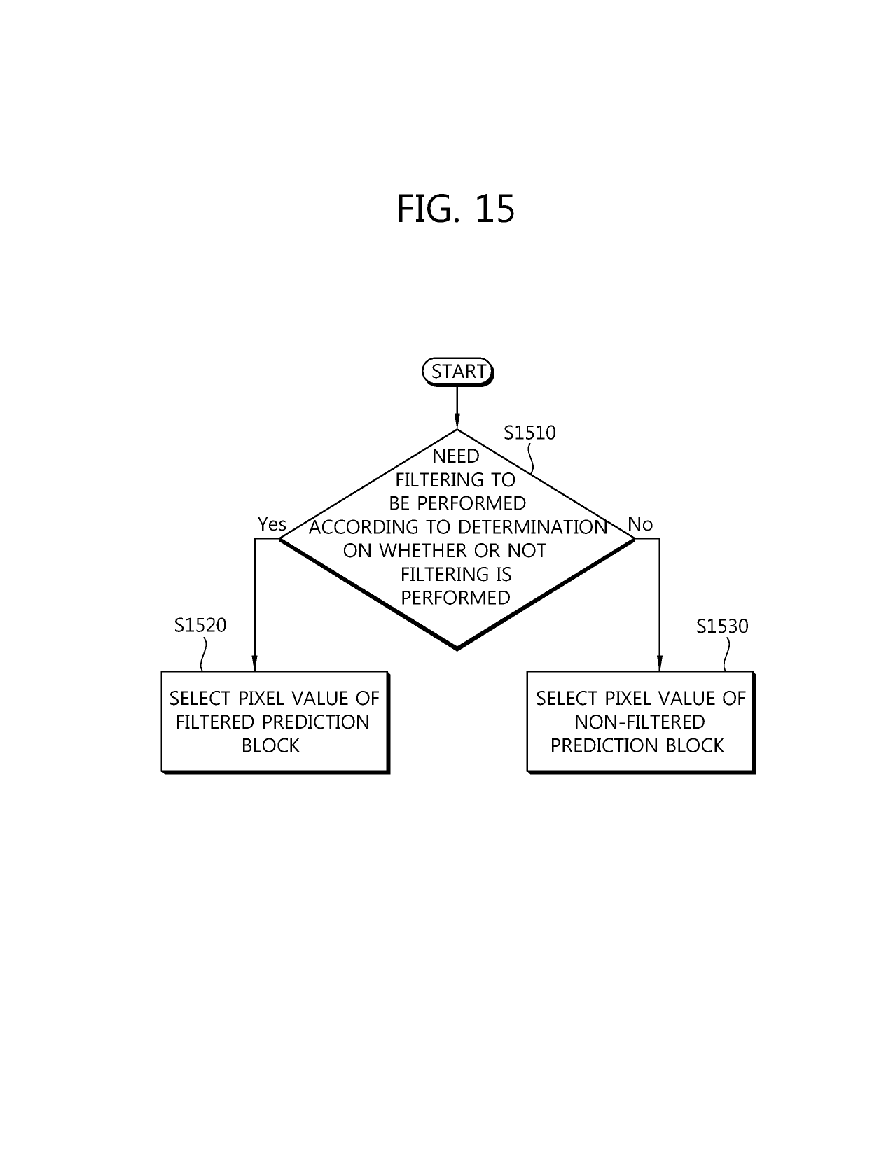

FIG. 15 is a flow chart showing an exemplary embodiment of a method of determining a pixel value of a prediction block of a current decoding object block.

Referring to FIG. 15, the decoding apparatus judges whether the filtering needs to be performed on the prediction block of the current decoding object block based on the determination on whether or not the filtering is performed (S1510). Whether or not the filtering is performed may be determined in the above-mentioned operation S1230 of determining whether or not the filtering is performed.

When the filtering is performed on the prediction block, the decoding apparatus determines that the pixel value of the filtered prediction block is the pixel value of the final prediction block (S1520). When the filtering is not performed on the prediction block, the decoding apparatus determines that the pixel value of the non-filtered prediction block is the pixel value of the final prediction block (S1530).

The decoding apparatus generates a recovery block using the recovered residual block and the final prediction block of which the pixel value is determined (S1260). The residual block is coded in the coding apparatus and is then transmitted to the decoding apparatus as described above in FIG. 4. The decoding apparatus may decode the residual block and use the decoded residual block to generate the recovery block.

As an example, the decoding apparatus may generate the recovery block by adding the final prediction block and the recovered residual block to each other. When the present invention is applied to the video decoding apparatus according to the exemplary embodiment of FIG. 2, the final prediction block may be added to the recovered residual block by the adder 255.

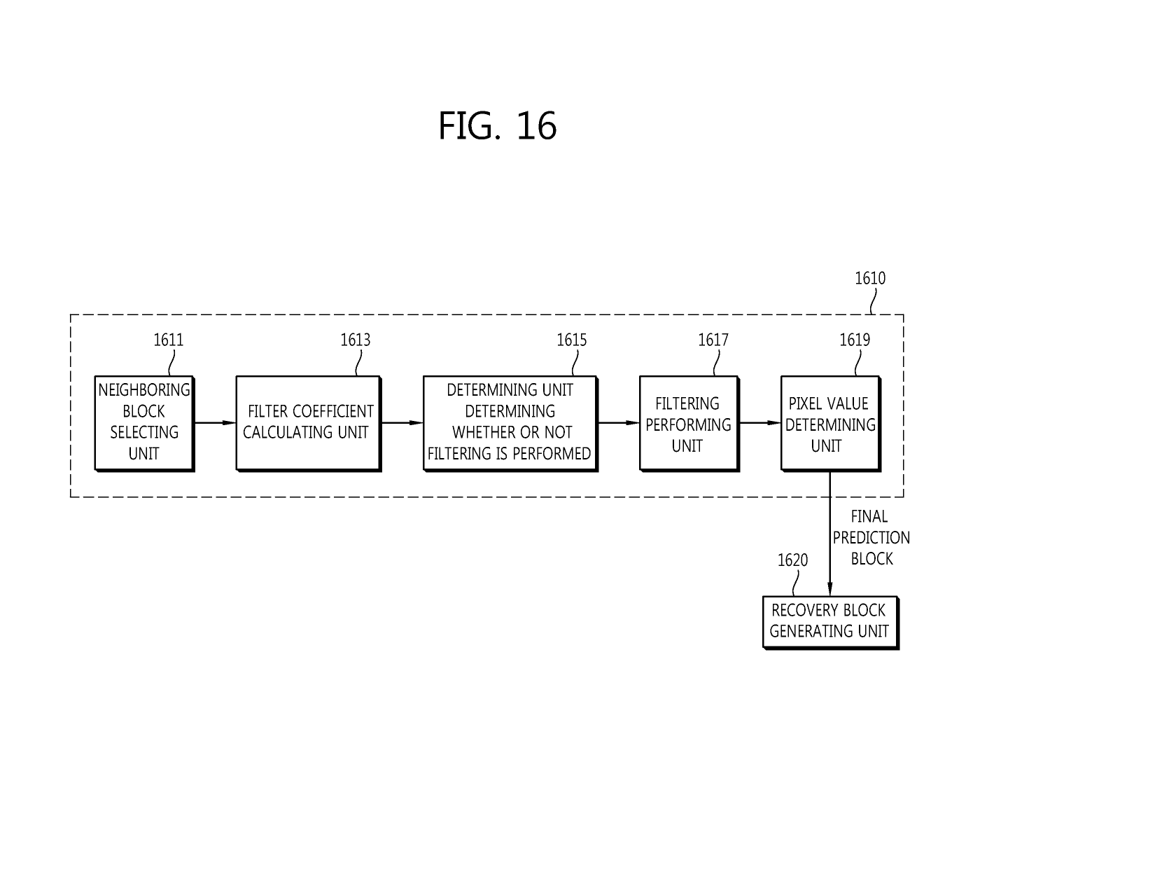

FIG. 16 is a block diagram schematically showing a configuration according to an exemplary embodiment of a prediction block filtering device applied to the video decoding apparatus. In the exemplary embodiment of FIG. 16, a detailed description of components or methods that are substantially the same as the components or methods described above with reference to FIGS. 12 to 15 will be omitted.

Referring to FIG. 16, FIG. 16 includes a prediction block filtering device 1610 and a recovery block generating unit 1620. The prediction block filtering device 1610 may include a neighboring block selecting unit 1611, a filter coefficient calculating unit 1613, a determining unit 1615 determining whether or not filtering is performed, a filtering performing unit 1617, and a pixel value determining unit 1619.

The prediction block filtering device 1610 may use the prediction block or the neighboring blocks of the current decoding object block in performing the filtering on the prediction block.

The prediction block of the current decoding object block may be a prediction block generated in the intra predictor 240 or the motion compensator 250 according to the exemplary embodiment of FIG. 2. In this case, the generated prediction block is not directly input but the final prediction block filtered through the prediction block filtering device 1610 may be input, to the adder 255. Therefore, the adder 255 may add the filtered final prediction block to the recovered residual block.

The neighboring block may be a block stored in the reference picture buffer 270 according to the exemplary embodiment of FIG. 2 or a separate memory. In addition, a neighboring recovery block or a neighboring prediction block generated during a video decoding process may also be used as the neighboring block as it is.

The neighboring block selecting unit 1611 may select the neighboring blocks used to calculate the filter coefficient.

As an example, the neighboring block selecting unit 1611 may select all neighboring recovery blocks adjacent to the decoding object block and prediction blocks corresponding thereto as the neighboring blocks for calculating the filter coefficient. Here, the neighboring block selecting unit 1611 may select all pixel value areas of the adjacent neighboring blocks or only some pixel value areas within the adjacent neighboring blocks.

As another example, the neighboring block selecting unit 1611 may select only neighboring prediction blocks associated with the prediction block of the current decoding object block among possible neighboring blocks and neighboring recovery blocks corresponding thereto. For example, the neighboring block selecting unit 1611 may judge the similarity between the prediction block of the decoding object block and the neighboring prediction block and then select the neighboring blocks used to calculate the filter coefficient using the similarity.

The filter coefficient calculating unit 1613 may calculate the filter coefficient using the selected neighboring recovery blocks and neighboring prediction blocks. As an example, the filter coefficient calculating unit 1613 may select the filter coefficient minimizing the MSE between the neighboring recovery blocks selected for the decoding object block and the neighboring prediction blocks corresponding thereto.

The determining unit 1615 determining whether or not filtering is performed may determine whether or not the filtering is performed on the prediction block of the current decoding object block.

As an example, when information on whether or not the filtering is performed is transmitted from the coding apparatus to the decoding apparatus, the determining unit 1615 determining whether or not filtering is performed may determine whether or not the filtering is performed using the decoded information on whether or not the filtering is performed.

As another example, the determining unit 1615 determining whether or not filtering is performed may determine whether or not the filtering is performed on the prediction block of the current decoding object block using the characteristic information between the prediction block of the current decoding object block and the neighboring blocks. As an example, the determining unit 1615 determining whether or not filtering is performed may determine whether or not the filtering is performed by judging the filtering performance of the neighboring blocks. As another example, the determining unit 1615 determining whether or not filtering is performed may also determine whether or not the filtering is performed by judging the similarity between the prediction block of the decoding object block and the neighboring prediction blocks.

The filtering performing unit 1617 may perform the filtering on the prediction block of the current decoding object block. Here, the filtering performing unit 1617 may perform the filtering using the filter coefficient calculated in the filter coefficient calculating unit 1613.

The pixel value determining unit 1619 may determine the pixel value of the prediction block of the current decoding object block. As an example, the pixel value determining unit 1619 may determine the pixel value of the final prediction block based on results on whether or not the filtering is performed determined in the determining unit 1615 determining whether or not filtering is performed.

The recovery block generating unit 1620 may generate the recovery block using the determined final prediction block and the recovered residual block. The recovery block generating unit 1620 may generate the recovery block by adding the final prediction block and the recovered residual block to each other. The recovery block generating unit 1620 may correspond to the adder 255 according to the exemplary embodiment of FIG. 2. As another example, the recovery block generating unit 1620 may include both of the adder 255 and the filter unit 260 according to the exemplary embodiment of FIG. 2 and further include other additional components.

With the video decoding apparatus and method according to the exemplary embodiment of the present invention, the filter coefficients adaptively calculated for each prediction block of each decoding object block rather than the fixed filter coefficient are used. In addition, whether or not the filtering is performed on the prediction block of each decoding object block may be adaptively selected. Therefore, the accuracy of the prediction picture is improved, such that the difference signal is minimized, thereby improving the coding performance.

Further, when it is judged that the coding result using the filtered prediction block provides better coding performance as compared to the coding result using the non-filtered prediction block, the filtering on a corresponding prediction block may be similarly performed in both of the coder and the decoder. Therefore, the added coding information may be minimized.

In the above-mentioned exemplary system, although the methods have been described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

1. A video decoding method comprising:
generating a first prediction block for a decoding object block;
calculating a filter coefficient based on neighboring blocks of the first prediction block; and
generating a second prediction block by performing filtering on the first prediction block using the filter coefficient when information on whether or not filtering is performed generated in a coding apparatus or a decoding apparatus or stored in the coding apparatus or the decoding apparatus indicates that the filtering is performed,
wherein the information on whether or not filtering is performed is information indicating whether or not the filtering is performed on the first prediction block.

2. The video decoding method of claim 1, wherein the neighboring block is at least one of a left block and an upper block each adjacent to one surface of the first prediction block and a left uppermost block, a right uppermost block, and a left lowermost block each adjacent to the first prediction block.

3. The video decoding method of claim 1, wherein in the calculating of the filter coefficient, the filter coefficient is calculated using only some areas within the neighboring block.

4. The video decoding method of claim 1, wherein in the neighboring block, similarity between a neighboring prediction block for the neighboring block and the first prediction block is a predetermined threshold or more.

5. The video decoding method of claim 1, wherein the information on whether or not filtering is performed is information generated by comparing rate-distortion cost values before and after the filtering is performed on the prediction block of the coding object block with each other in the coding apparatus, indicating that the filtering is not performed when the rate-distortion cost value before the filtering is performed on the prediction block of the coding object block is smaller than the rate-distortion cost value after the filtering is performed on the prediction block of the coding object block, indicating that the filtering is performed when the rate-distortion cost value before the filtering is performed on the prediction block of the coding object block is larger than the rate-distortion cost value after the filtering is performed on the prediction block of the coding object block, and coded in the coding apparatus and transmitted to the decoding apparatus.

6. The video decoding method of claim 1, wherein the information on whether or not filtering is performed is information generated based on information on the neighboring block in the decoding apparatus.

7. The video decoding method of claim 6, wherein the information on whether or not filtering is performed is generated based on performance of the filtering performed on the neighboring block using the filter coefficient.

8. The video decoding method of claim 6, wherein the information on whether or not filtering is performed is generated based on similarity between the prediction block and the neighboring prediction block.

9. The video decoding method of claim 1, further comprising:
generating a recovery block using the second prediction block and a recovered residual block when the filtering is performed on the first prediction block; and
generating a recovery block using the first prediction block and the recovered residual block when the filtering is not performed on the first prediction block.

10. A video decoding apparatus comprising:
a filter coefficient calculating unit calculating a filter coefficient based on neighboring blocks of a first prediction block;
a filtering performing unit generating a second prediction block by performing filtering on the first prediction block using the filter coefficient when information on whether or not filtering is performed generated in a coding apparatus or a decoding apparatus or stored in the coding apparatus or the decoding apparatus indicates that the filtering is performed; and
a recovery block generating unit generating a recovery block using the second prediction block and a recovered residual block when the filtering is performed on the first prediction block and generating a recovery block using the first prediction block and the recovered residual block when the filtering is not performed on the first prediction block,
wherein the information on whether or not filtering is performed is information indicating whether or not the filtering is performed on the first prediction block.

11. A video coding method comprising:
generating a first prediction block for a coding object block;
calculating a filter coefficient based on neighboring blocks of the first prediction block; and
generating a second prediction block by performing filtering on the first prediction block using the filter coefficient when information on whether or not filtering is performed generated in a coding apparatus or stored in the coding apparatus indicates that the filtering is performed,
wherein the information on whether or not filtering is performed is information indicating whether or not the filtering is performed on the first prediction block.

12. The video coding method of claim 11, wherein the neighboring block is at least one of a left block and an upper block each adjacent to one surface of the first prediction block and a left uppermost block, a right uppermost block, and a left lowermost block each adjacent to the first prediction block.

13. The video coding method of claim 11, wherein in the calculating of the filter coefficient, the filter coefficient is calculated using only some areas within the neighboring block.

14. The video coding method of claim 11, wherein the information on whether or not filtering is performed indicates that the filtering is always performed.

15. The video coding method of claim 14, further comprising:
generating a residual block using the first prediction block and an input block when a rate-distortion cost value for the first prediction block is smaller than a rate-distortion cost value for the second prediction block; and
generating a residual block using the second prediction block and the input block when the rate-distortion cost value for the first prediction block is larger than the rate-distortion cost value for the second prediction block.

16. The video coding method of claim 11, wherein the information on whether or not filtering is performed is information generated based on information on the neighboring block in the coding apparatus.

17. The video coding method of claim 16, wherein the information on whether or not filtering is performed is generated based on performance of the filtering performed on the neighboring block using the filter coefficient.

18. The video coding method of claim 16, wherein the information on whether or not filtering is performed is generated based on similarity between the prediction block and the neighboring prediction block.

19. The video coding method of claim 16, further comprising:
generating a residual block using the second prediction block and an input block when the filtering is performed on the first prediction block; and
generating a residual block using the first prediction block and the input block when the filtering is not performed on the first prediction block.

20. The video coding method of claim 19, wherein in the generating of the residual block when the filtering is performed on the first prediction block, the residual block is generated using the first prediction block and the input block when a rate-distortion cost value for the first prediction block is smaller than a rate-distortion cost value for the second prediction block and is generated using the second prediction block and the input block when the rate-distortion cost value for the first prediction block is larger than the rate-distortion cost value for the second prediction block.
